(19) United States
(12) Patent Application Publication
(10) Pub. No.: US 2026/0353160 A1
(43) Pub. Date: Nov. 5, 2026

(54) METHOD FOR RECEIVING MESSAGE IN WIRELESS COMMUNICATION SYSTEM AND DEVICE THEREFOR

(71) Applicant: LG ELECTRONICS INC., Seoul (KR)

(72) Inventors: Yunjong KIM, Seoul (KR); Hanbyul SEO, Seoul (KR); Jaihyun BYUN, Seoul (KR)

(21) Appl. No.: 19/476,621

(22) PCT Filed: Apr. 19, 2024
(86) PCT No.: PCT/KR2024/005284

§ 371 Date: Oct. 17, 2025

(30) Foreign Application Priority Data
Apr. 21, 2023 (KR) 10-2023-0052871
May 17, 2023 (KR) 10-2023-0063818

(51) Int. Cl. H04W 28/02; H04W 12/106

(52) U.S. Cl. CPC H04W 28/02; H04W 12/106

(57) ABSTRACT

A device: periodically receives at least one message from at least one UE; and processes the at least one message in accordance with a message processing order determined on the basis of processing priority, wherein the processing priority is determined on the basis of a default priority determination rule and the time interval of message processing for the same UE.

### CROSS-REFERENCE TO RELATED APPLICATIONS

This application is a National Phase application under 35 U.S.C. 371 of International Application No. PCT/KR2024/005284, filed on Apr. 19, 2024, which claims the benefit of Korean Application No. 10-2023-0052871 filed on Apr. 21, 2023 and No. 10-2023-0063818 filed on May 17, 2023, the contents of which are incorporated by reference herein in their entirety.

### TECHNICAL FIELD

The present disclosure relates to a method of processing a received message based on a processing priority of a user equipment (UE) in a wireless communication system and a device therefor.

### BACKGROUND

Wireless communication systems have been widely deployed to provide various types of communication services such as voice or data. In general, a wireless communication system is a multiple access system that supports communication of multiple users by sharing available system resources (a bandwidth, transmission power, etc.). Examples of multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multi carrier frequency division multiple access (MC-FDMA) system.

A sidelink (SL) refers to a communication method in which a direct link is established between user equipment (UE), and voice or data is directly exchanged between terminals without going through a base station (BS). SL is being considered as one way to solve the burden of the base station due to the rapidly increasing data traffic.

V2X (vehicle-to-everything) refers to a communication technology that exchanges information with other vehicles, pedestrians, and infrastructure-built objects through wired/wireless communication. V2X may be divided into four types: vehicle-to-vehicle (V2V), vehicle-to-infrastructure (V2I), vehicle-to-network (V2N), and vehicle-to-pedestrian (V2P). V2X communication may be provided through a PC5 interface and/or a Uu interface.

As more and more communication devices require larger communication capacities in transmitting and receiving signals, there is a need for mobile broadband communication improved from the legacy radio access technology. Accordingly, communication systems considering services/UEs sensitive to reliability and latency are under discussion. A next-generation radio access technology in consideration of enhanced mobile broadband communication, massive Machine Type Communication (MTC), and Ultra-Reliable and Low Latency Communication (URLLC) may be referred to as new radio access technology (RAT) or new radio (NR). Even in NR, vehicle-to-everything (V2X) communication may be supported.

FIG. 1 is a diagram comparing RAT-based V2X communication before NR with NR-based V2X communication.

Regarding V2X communication, in RAT prior to NR, a scheme for providing a safety service based on V2X messages such as a basic safety message (BSM), a cooperative awareness message (CAM), and a decentralized environmental notification message (DENM) was mainly discussed. The V2X message may include location information, dynamic information, and attribute information. For example, the UE may transmit a periodic message type CAM and/or an event triggered message type DENM to another UE.

For example, the CAM may include dynamic state information about a vehicle such as direction and speed, vehicle static data such as dimensions, and basic vehicle information such as external lighting conditions and route details. For example, a UE may broadcast the CAM, and the CAM latency may be less than 100 ms. For example, when an unexpected situation such as a breakdown of the vehicle or an accident occurs, the UE may generate a DENM and transmit the same to another UE. For example, all vehicles within the transmission coverage of the UE may receive the CAM and/or DENM. In this case, the DENM may have a higher priority than the CAM.

Regarding V2X communication, various V2X scenarios have been subsequently introduced in NR. For example, the various V2X scenarios may include vehicle platooning, advanced driving, extended sensors, and remote driving.

For example, based on vehicle platooning, vehicles may dynamically form a group and move together. For example, to perform platoon operations based on vehicle platooning, vehicles belonging to the group may receive periodic data from a leading vehicle. For example, the vehicles belonging to the group may reduce or increase the distance between the vehicles based on the periodic data.

For example, based on advanced driving, a vehicle may be semi-automated or fully automated. For example, each vehicle may adjust trajectories or maneuvers based on data acquired from local sensors of nearby vehicles and/or nearby logical entities. Also, for example, each vehicle may share driving intention with nearby vehicles.

For example, on the basis of extended sensors, raw data or processed data acquired through local sensors, or live video data may be exchanged between a vehicle, a logical entity, UEs of pedestrians and/or a V2X application server. Thus, for example, the vehicle may recognize an environment that is improved over an environment that may be detected using its own sensor.

For example, for a person who cannot drive or a remote vehicle located in a dangerous environment, a remote driver or V2X application may operate or control the remote vehicle based on remote driving. For example, when a route is predictable as in the case of public transportation, cloud computing-based driving may be used to operate or control the remote vehicle. For example, access to a cloud-based back-end service platform may be considered for remote driving.

A method to specify service requirements for various V2X scenarios such as vehicle platooning, advanced driving, extended sensors, and remote driving is being discussed in the NR-based V2X communication field.

### SUMMARY

An object of the present disclosure is to provide a method of accurately and efficiently processing a received message in a wireless communication system and a device therefor.

It will be appreciated by persons skilled in the art that the objects that could be achieved with the various embodiments of the present disclosure are not limited to what has been particularly described hereinabove and the above and other objects that the various embodiments of the present disclosure could achieve will be more clearly understood from the following detailed description.

According to an aspect, a method of receiving a message by a user equipment (UE) in a wireless communication system includes periodically receiving at least one message from at least one UE, and processing the at least one message according to a message processing order determined based on a processing priority, wherein the processing priority is determined based on a default priority determination rule and a processing time interval of messages for the same UE.

Based on the processing time interval for a first UE among the at least one UE being greater than or equal to a specific threshold time, a processing priority for a message of the first UE may be determined by applying a first weight to a priority determined based on the default priority determination rule.

Based on the processing time interval for the first UE being less than a specific threshold time, the processing priority for the message of the first UE may be determined based only on the default priority determination rule without applying the first weight.

The first weight may be determined based on a size of the processing time interval.

The first weight may be determined based on a message processing capability of the UE and mobility information included in a message of the first UE, and the specific threshold time may be changed based on a type of the message of the first UE and the mobility information of the first UE included in the message of the first UE.

The default priority determination rule may be a rule for determining a priority between messages of the same message type received periodically based on at least one of a time stored in a buffer of the UE, a distance between the at least one UE and the UE, mobility information of the at least one UE, or a driving environment.

When at least one message received from the at least one UE is of a different message type, the reception UE may determine a processing priority between messages of different types by applying a second weight to the default priority for each type of the message.

The second weight may be determined based on at least one of a status of the reception UE, event information of a message, a priority related to transmission of the message, the processing time interval, or a reliability level of the message.

Processing of the message may include operations of verifying a certificate for the received message, processing encrypted data, and verifying validity of data.

According to another aspect, a non-transitory computer-readable storage medium having recorded thereon instructions for performing the method of receiving the message described above may be provided.

According to another aspect, a device may be provided that performs the method of receiving a message as described above.

According to another aspect, a processing device may be provided that controls a UE for performing the method of receiving a message as described above.

According to another aspect, a method of receiving a message by a network in a wireless communication system includes periodically receiving at least one message from at least one user equipment (UE), and processing the at least one message according to a message processing order determined based on a processing priority, wherein the processing priority is determined based on a default priority determination rule and a processing time interval of messages for the same UE.

According to an embodiment, a received message in a wireless communication system may be accurately and efficiently processed.

Effects to be achieved by embodiment(s) are not limited to what has been particularly described hereinabove and other effects not mentioned herein will be more clearly understood by persons skilled in the art to which embodiment(s) pertain from the following detailed description.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain the principle of the disclosure.

FIG. 1 is a diagram for explaining by comparing V2X communication based on RAT before NR and V2X communication based on NR.

FIG. 2 illustrates the structure of an LTE system to which embodiment(s) are applicable.

FIG. 3 illustrates the structure of an NR system to which embodiment(s) are applicable.

FIG. 4 illustrates the structure of an NR radio frame to which embodiment(s) are applicable.

FIG. 5 illustrates the slot structure of an NR frame to which embodiment(s) are applicable.

FIG. 6 illustrates a radio protocol architecture for SL communication.

FIG. 7 illustrates UEs performing V2X or SL communication.

FIG. 8 illustrates resource units for V2X or SL communication.

FIG. 9 is a diagram for explaining an ITS station reference architecture.

FIG. 10 illustrates an exemplary structure of an ITS station that may be designed and applied based on a reference architecture.

FIG. 11 and FIG. 12 are diagrams for explaining a method of determining a processing priority of a message based on a processing time interval of a message.

FIG. 13 is a diagram for explaining transmission priorities by message type.

FIG. 14 is a diagram illustrating a method of determining a priority for each message type.

FIG. 15 is a flowchart illustrating a method of applying a priority weight to a default priority per message.

FIG. 16 is a diagram for explaining a method of determining a processing priority of received messages by a UE.

FIG. 17 illustrates a communication system applied to the present disclosure.

FIG. 18 illustrates wireless devices applicable to the present disclosure.

FIG. 19 illustrates another example of a wireless device to which the present disclosure is applied.

FIG. 20 illustrates a vehicle or an autonomous driving vehicle applied to the present disclosure.

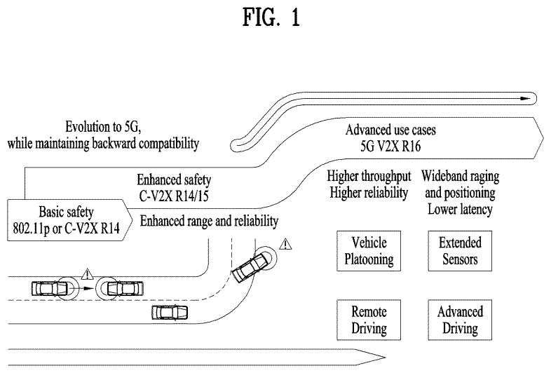

### DETAILED DESCRIPTION

The wireless communication system is a multiple access system that supports communication with multiple users by sharing available system resources (e.g., bandwidth, transmission power, etc.). Examples of the multiple access system include a code division multiple access (CDMA) system, a frequency division multiple access (FDMA) system, a time division multiple access (TDMA) system, an orthogonal frequency division multiple access (OFDMA) system, a single carrier frequency (SC-FDMA) system, a multi carrier frequency division multiple access (MC-FDMA) system, and the like.

A sidelink refers to a communication scheme in which a direct link is established between user equipments (UEs) to directly exchange voice or data between UEs without assistance from a base station (BS). The sidelink is being considered as one way to address the burden on the BS caused by rapidly increasing data traffic.

Vehicle-to-everything (V2X) refers to a communication technology for exchanging information with other vehicles, pedestrians, and infrastructure-built objects through wired/wireless communication. V2X may be divided into four types: vehicle-to-vehicle (V2V), vehicle-to-infrastructure (V2I), vehicle-to-network (V2N), and vehicle-to-pedestrian (V2P). V2X communication may be provided through a PC5 interface and/or a Uu interface.

As more and more communication devices require larger communication capacities in transmitting and receiving signals, there is a need for mobile broadband communication improved from the legacy radio access technology. Accordingly, communication systems considering services/UEs sensitive to reliability and latency are under discussion. A next-generation radio access technology in consideration of enhanced mobile broadband communication, massive MTC, and Ultra-Reliable and Low Latency Communication (URLLC) may be referred to as new radio access technology (RAT) or new radio (NR). Even in NR, V2X communication may be supported.

Techniques described herein may be used in various wireless access systems such as code division multiple access (CDMA), frequency division multiple access (FDMA), time division multiple access (TDMA), orthogonal frequency division multiple access (OFDMA), single carrier-frequency division multiple access (SC-FDMA), etc. CDMA may be implemented as a radio technology such as universal terrestrial radio access (UTRA) or CDMA2000. TDMA may be implemented as a radio technology such as global system for mobile communications (GSM)/general packet radio service (GPRS)/Enhanced Data Rates for GSM Evolution (EDGE). OFDMA may be implemented as a radio technology such as IEEE 802.11 (Wi-Fi), IEEE 802.16 (WiMAX), IEEE 802.20, evolved-UTRA (E-UTRA) etc. UTRA is a part of universal mobile telecommunications system (UMTS). 3GPP LTE is a part of Evolved UMTS (E-UMTS) using E-UTRA. 3GPP LTE employs OFDMA for downlink and SC-FDMA for uplink. LTE-A is an evolution of 3GPP LTE. 3GPP NR (New Radio or New Radio Access Technology) is an evolved version of 3GPP LTE/LTE-A/LTE-A pro.

5G NR is a successor technology of LTE-A and is a new clean-slate mobile communication system with characteristics such as high performance, low latency, and high availability. 5G NR may utilize all available spectrum resources, from low frequency bands below 1 GHz to intermediate frequency bands from 1 GHz to 10 GHz and high frequency (millimeter wave) bands above 24 GHz.

For clarity of explanation, LTE-A or 5G NR is mainly described, but the technical spirit of the embodiment(s) is not limited thereto

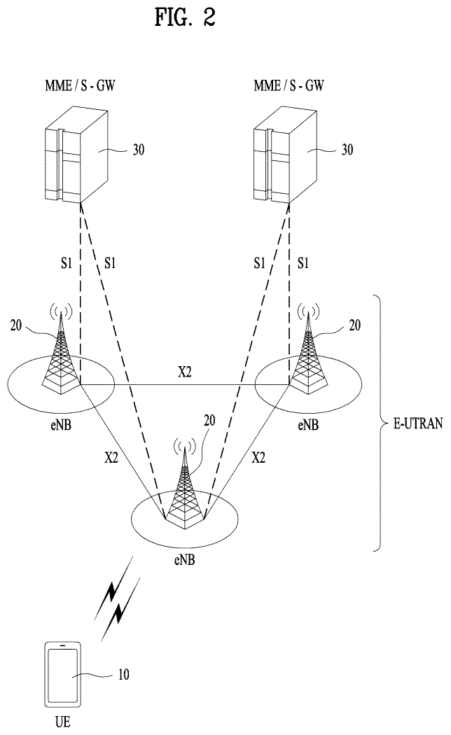

FIG. 2 illustrates the structure of an LTE system to which the present disclosure is applicable. This may also be called an evolved UMTS terrestrial radio access network (E-UTRAN) or LTE/LTE-A system.

Referring to FIG. 2, the E-UTRAN includes evolved Node Bs (eNBs) 20 which provide a control plane and a user plane to UEs 10. A UE 10 may be fixed or mobile, and may also be referred to as a mobile station (MS), user terminal (UT), subscriber station (SS), mobile terminal (MT), or wireless device. An eNB 20 is a fixed station communication with the UE 10 and may also be referred to as a base station (BS), a base transceiver system (BTS), or an access point.

eNBs 20 may be connected to each other via an X2 interface. An eNB 20 is connected to an evolved packet core (EPC) 39 via an S1 interface. More specifically, the eNB 20 is connected to a mobility management entity (MME) via an S1-MME interface and to a serving gateway (S-GW) via an S1-U interface.

The EPC 30 includes an MME, an S-GW, and a packet data network-gateway (P-GW). The MME has access information or capability information about UEs, which are mainly used for mobility management of the UEs. The S-GW is a gateway having the E-UTRAN as an end point, and the P-GW is a gateway having a packet data network (PDN) as an end point.

Based on the lowest three layers of the open system interconnection (OSI) reference model known in communication systems, the radio protocol stack between a UE and a network may be divided into Layer 1 (L1), Layer 2 (L2) and Layer 3 (L3). These layers are defined in pairs between a UE and an Evolved UTRAN (E-UTRAN), for data transmission via the Uu interface. The physical (PHY) layer at L1 provides an information transfer service on physical channels. The radio resource control (RRC) layer at L3 functions to control radio resources between the UE and the network. For this purpose, the RRC layer exchanges RRC messages between the UE and an eNB.

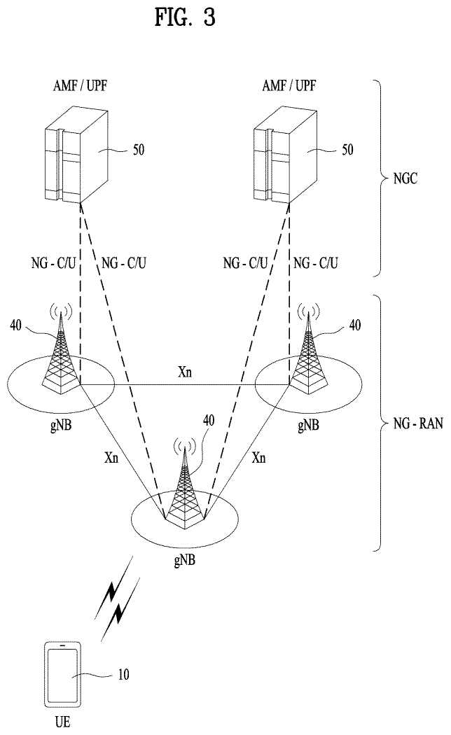

FIG. 3 illustrates the structure of a NR system to which the present disclosure is applicable.

Referring to FIG. 3, a next generation radio access network (NG-RAN) may include a next generation Node B (gNB) and/or an eNB, which provides user-plane and control-plane protocol termination to a UE. In FIG. 3, the NG-RAN is shown as including only gNBs, by way of example. A gNB and an eNB are connected to each other via an Xn interface. The gNB and the eNB are connected to a 5G core network (5GC) via an NG interface. More specifically, the gNB and the eNB are connected to an access and mobility management function (AMF) via an NG-C interface and to a user plane function (UPF) via an NG-U interface.

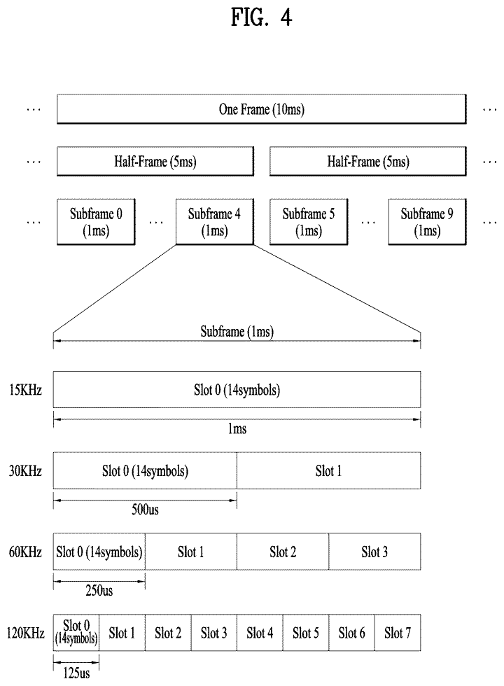

FIG. 4 illustrates the structure of a NR radio frame to which the present disclosure is applicable.

Referring to FIG. 4, a radio frame may be used for UL transmission and DL transmission in NR. A radio frame is 10 ms in length, and may be defined by two 5-ms half-frames. An HF may include five 1-ms subframes. A subframe may be divided into one or more slots, and the number of slots in an SF may be determined according to a subcarrier spacing (SCS). Each slot may include 12 or 14 OFDM (A) symbols according to a cyclic prefix (CP).

In a normal CP (NCP) case, each slot may include 14 symbols, whereas in an extended CP (ECP) case, each slot may include 12 symbols. Herein, a symbol may be an OFDM symbol (or CP-OFDM symbol) or an SC-FDMA symbol (or DFT-s-OFDM symbol).

Table 1 below lists the number of symbols per slot N^{slot}_{symb}, the number of slots per frame N^{frame,u}ₛₗₒₜ, and the number of slots per subframe N^{subframe,u}ₛₗₒₜ according to an SCS configuration u in the NCP case.

TABLE 1

| | | | |
|---|---|---|---|
| SCS (15*2u) | N^{slot}_{symb} | N^{frame, u}ₛₗₒₜ | N^{subframe, u}ₛₗₒₜ |

| | | | | |
|---|---|---|---|---|
| 15 kHz | (u = 0) | 14 | 10 | 1 |
| 30 kHz | (u = 1) | 14 | 20 | 2 |
| 60 kHz | (u = 2) | 14 | 40 | 4 |
| 120 kHz | (u = 3) | 14 | 80 | 8 |
| 240 kHz | (u = 4) | 14 | 160 | 16 |

Table 2 below lists the number of symbols per slot, the number of slots per frame, and the number of slots per subframe according to an SCS in the ECP case.

TABLE 2

| SCS (15*2\hat{ }u) | N^{slot}_{symb} | N^{frame, u}ₛₗₒₜ | N^{subframe, u}ₛₗₒₜ |
|---|---|---|---|
| 60 kHz (u = 2) | 12 | 40 | 4 |

In the NR system, different OFDM (A) numerologies (e.g., SCSs, CP lengths, etc.) may be configured for a plurality of cells aggregated for one UE. Thus, the (absolute) duration of a time resource (e.g., SF, slot, or TTI) including the same number of symbols may differ between the aggregated cells (such a time resource is commonly referred to as a time unit (TU) for convenience of description).

In NR, multiple numerologies or SCSs to support various 5G services may be supported. For example, a wide area in conventional cellular bands may be supported when the SCS is 15 kHz, and a dense urban environment, lower latency, and a wider carrier bandwidth may be supported when the SCS is 30 kHz/60 kHz. When the SCS is 60 kHz or higher, a bandwidth wider than 24.25 GHz may be supported to overcome phase noise.

The NR frequency band may be defined as two types of frequency ranges. The two types of frequency ranges may be FR1 and FR2. The numerical values of the frequency ranges may be changed. For example, the two types of frequency ranges may be configured as shown in Table 3 below. Among the frequency ranges used in the NR system, FR1 may represent “sub 6 GHz range” and FR2 may represent “above 6 GHz range” and may be called millimeter wave (mmW).

TABLE 3

| Frequency Range | Corresponding | Subcarrier |
|---|---|---|
| designation | frequency range | Spacing (SCS) |
| FR1 | 450 MHz-6000 MHz | 15, 30, 60 kHz |
| FR2 | 24250 MHz-52600 MHz | 60, 120, 240 kHz |

As mentioned above, the numerical values of the frequency ranges of the NR system may be changed. For example, FR1 may include a band of 410 MHz to 7125 MHz as shown in Table 4 below. That is, FR1 may include a frequency band of 6 GHz (or 5850 MHz, 5900 MHz, 5925 MHz, etc.) or higher. For example, the frequency band of 6 GHz (or 5850 MHz, 5900 MHz, 5925 MHz, etc.) or higher included in FR1 may include an unlicensed band. The unlicensed band may be used for various purposes, for example, for communication for vehicles (e.g., autonomous driving).

TABLE 4

| Frequency Range | Corresponding | Subcarrier |
|---|---|---|
| designation | frequency range | Spacing (SCS) |
| FR1 | 410 MHz-7125 MHz | 15, 30, 60 kHz |
| FR2 | 24250 MHz-52600 MHz | 60, 120, 240 kHz |

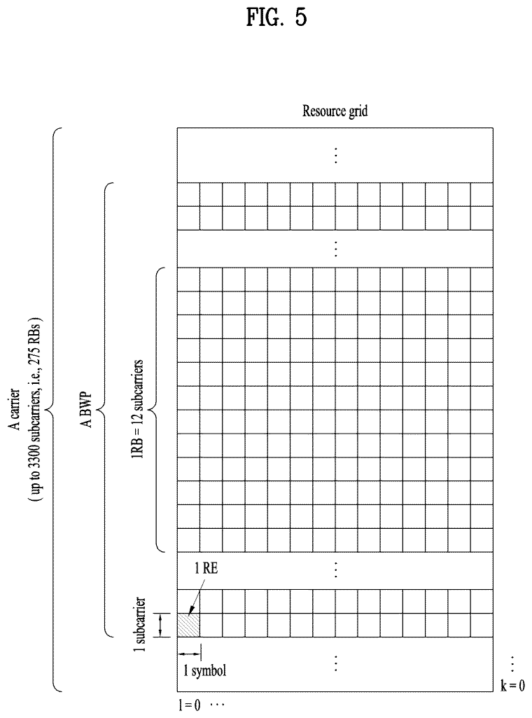

FIG. 5 illustrates the slot structure of a NR frame to which the present disclosure is applicable.

Referring to FIG. 5, one slot includes a plurality of symbols in the time domain. For example, one slot may include 14 symbols in a normal CP and 12 symbols in an extended CP. Alternatively, one slot may include 7 symbols in the normal CP and 6 symbols in the extended CP.

A carrier may include a plurality of subcarriers in the frequency domain. A resource block (RB) is defined as a plurality of consecutive subcarriers (e.g., 12 subcarriers) in the frequency domain. A bandwidth part (BWP) may be defined as a plurality of consecutive (P) RBs in the frequency domain, and the BWP may correspond to one numerology (e.g., SCS, CP length, etc.). The carrier may include up to N (e.g., 5) BWPs. Data communication may be conducted in an activated BWP. In a resource grid, each element may be referred to as a resource element (RE) and may be mapped to one complex symbol.

The wireless interface between UEs or the wireless interface between a UE and a network may be composed of an L1 layer, an L2 layer, and an L3 layer. In various embodiments of the present disclosure, the L1 layer may represent a physical layer. The L2 layer may represent, for example, at least one of a MAC layer, an RLC layer, a PDCP layer, and an SDAP layer. The L3 layer may represent, for example, an RRC layer.

Hereinafter, V2X or sidelink (SL) communication will be described.

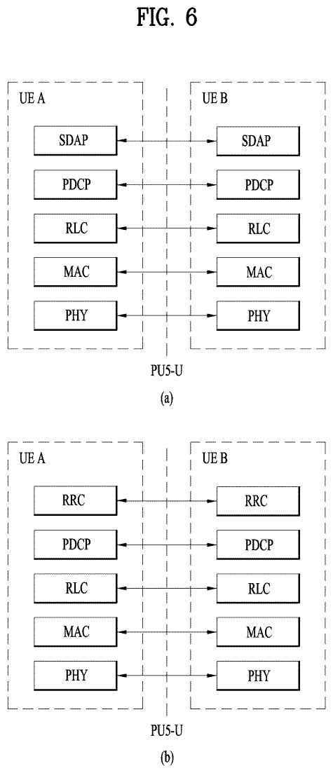

FIG. 6 illustrates a radio protocol architecture for SL communication. Specifically, FIG. 6-(a) shows a user plane protocol stack of NR, and FIG. 6-(b) shows a control plane protocol stack of NR.

Hereinafter, a sidelink synchronization signal (SLSS) and synchronization information will be described.

The SLSS is an SL-specific sequence, and may include a primary sidelink synchronization signal (PSSS) and a secondary sidelink synchronization signal (SSSS). The PSSS may be referred to as a sidelink primary synchronization signal (S-PSS), and the SSSS may be referred to as a sidelink secondary synchronization signal (S-SSS). For example, length-127 M-sequences may be used for the S-PSS, and length-127 gold sequences may be used for the S-SSS. For example, the UE may detect an initial signal and acquire synchronization using the S-PSS. For example, the UE may acquire detailed synchronization using the S-PSS and the S-SSS, and may detect a synchronization signal ID.

A physical sidelink broadcast channel (PSBCH) may be a (broadcast) channel on which basic (system) information that the UE needs to know first before transmission and reception of an SL signal is transmitted. For example, the basic information may include SLSS related information, a duplex mode (DM), time division duplex uplink/downlink (TDD UL/DL) configuration, resource pool related information, the type of an application related to the SLSS, a subframe offset, and broadcast information. For example, for evaluation of PSBCH performance, the payload size of PSBCH in NR V2X may be 56 bits including CRC of 24 bits.

The S-PSS, S-SSS, and PSBCH may be included in a block format (e.g., an SL synchronization signal (SS)/PSBCH block, hereinafter sidelink-synchronization signal block (S-SSB)) supporting periodic transmission. The S-SSB may have the same numerology (i.e., SCS and CP length) as a physical sidelink control channel (PSCCH)/physical sidelink shared channel (PSSCH) in the carrier, and the transmission bandwidth thereof may be within a (pre) set sidelink BWP (SL BWP). For example, the bandwidth of the S-SSB may be 11 resource blocks (RBs). For example, the PSBCH may span 11 RBs. The frequency position of the S-SSB may be (pre) set. Accordingly, the UE does not need to perform hypothesis detection at a frequency to discover the S-SSB in the carrier.

In the NR SL system, a plurality of numerologies having different SCSs and/or CP lengths may be supported. In this case, as the SCS increases, the length of the time resource in which the transmitting UE transmits the S-SSB may be shortened. Thereby, the coverage of the S-SSB may be narrowed. Accordingly, in order to guarantee the coverage of the S-SSB, the transmitting UE may transmit one or more S-SSBs to the receiving UE within one S-SSB transmission period according to the SCS. For example, the number of S-SSBs that the transmitting UE transmits to the receiving UE within one S-SSB transmission period may be pre-configured or configured for the transmitting UE. For example, the S-SSB transmission period may be 160 ms. For example, for all SCSs, the S-SSB transmission period of 160 ms may be supported.

For example, when the SCS is 15 kHz in FR1, the transmitting UE may transmit one or two S-SSBs to the receiving UE within one S-SSB transmission period. For example, when the SCS is 30 kHz in FR1, the transmitting UE may transmit one or two S-SSBs to the receiving UE within one S-SSB transmission period. For example, when the SCS is 60 kHz in FR1, the transmitting UE may transmit one, two, or four S-SSBs to the receiving UE within one S-SSB transmission period.

For example, when the SCS is 60 kHz in FR2, the transmitting UE may transmit 1, 2, 4, 8, 16 or 32 S-SSBs to the receiving UE within one S-SSB transmission period. For example, when SCS is 120 kHz in FR2, the transmitting UE may transmit 1, 2, 4, 8, 16, 32 or 64 S-SSBs to the receiving UE within one S-SSB transmission period.

When the SCS is 60 kHz, two types of CPs may be supported. In addition, the structure of the S-SSB transmitted from the transmitting UE to the receiving UE may depend on the CP type. For example, the CP type may be normal CP (NCP) or extended CP (ECP). Specifically, for example, when the CP type is NCP, the number of symbols to which the PSBCH is mapped in the S-SSB transmitted by the transmitting UE may be 9 or 8. On the other hand, for example, when the CP type is ECP, the number of symbols to which the PSBCH is mapped in the S-SSB transmitted by the transmitting UE may be 7 or 6. For example, the PSBCH may be mapped to the first symbol in the S-SSB transmitted by the transmitting UE. For example, upon receiving the S-SSB, the receiving UE may perform an automatic gain control (AGC) operation in the period of the first symbol for the S-SSB.

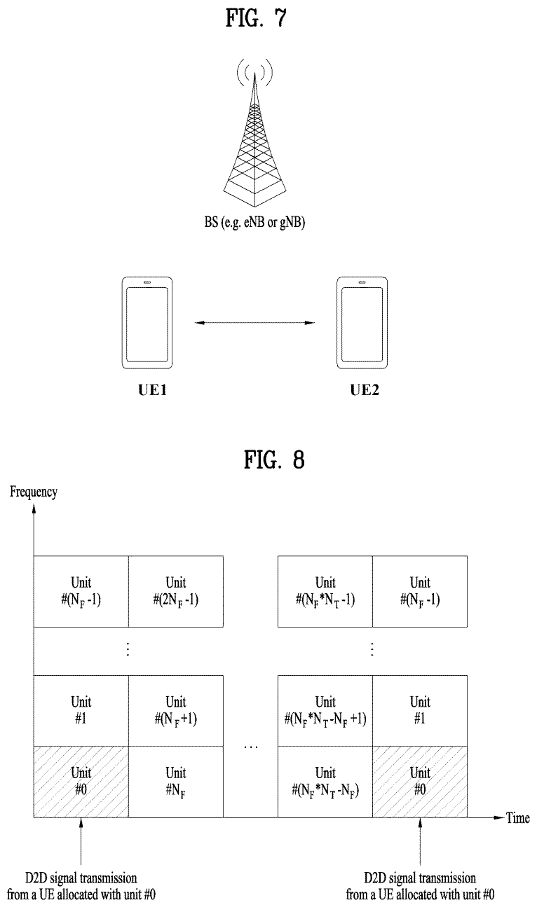

FIG. 7 illustrates UEs performing V2X or SL communication.

Referring to FIG. 7, in V2X or SL communication, the term UE may mainly refer to a user's UE. However, when network equipment such as a BS transmits and receives signals according to a communication scheme between UEs, the BS may also be regarded as a kind of UE. For example, UE 1 may be the first device 100, and UE 2 may be the second device 200.

For example, UE 1 may select a resource unit corresponding to a specific resource in a resource pool, which represents a set of resources. Then, UE 1 may transmit an SL signal through the resource unit. For example, UE 2, which is a receiving UE, may receive a configuration of a resource pool in which UE 1 may transmit a signal, and may detect a signal of UE 1 in the resource pool.

Here, when UE 1 is within the connection range of the BS, the BS may inform UE 1 of a resource pool. On the other hand, when the UE 1 is outside the connection range of the BS, another UE may inform UE 1 of the resource pool, or UE 1 may use a preconfigured resource pool.

In general, the resource pool may be composed of a plurality of resource units, and each UE may select one or multiple resource units and transmit an SL signal through the selected units.

FIG. 8 illustrates resource units for V2X or SL communication.

Referring to FIG. 8, the frequency resources of a resource pool may be divided into NF sets, and the time resources of the resource pool may be divided into NT sets. Accordingly, a total of NF*NT resource units may be defined in the resource pool. FIG. 8 shows an exemplary case where the resource pool is repeated with a periodicity of NT subframes.

As shown in FIG. 8, one resource unit (e.g., Unit #0) may appear periodically and repeatedly. Alternatively, in order to obtain a diversity effect in the time or frequency dimension, an index of a physical resource unit to which one logical resource unit is mapped may change in a predetermined pattern over time. In this structure of resource units, the resource pool may represent a set of resource units available to a UE which intends to transmit an SL signal.

Resource pools may be subdivided into several types. For example, according to the content in the SL signal transmitted in each resource pool, the resource pools may be divided as follows.

(1) Scheduling assignment (SA) may be a signal including information such as a position of a resource through which a transmitting UE transmits an SL data channel, a modulation and coding scheme (MCS) or multiple input multiple output (MIMO) transmission scheme required for demodulation of other data channels, and timing advance (TA). The SA may be multiplexed with SL data and transmitted through the same resource unit. In this case, an SA resource pool may represent a resource pool in which SA is multiplexed with SL data and transmitted. The SA may be referred to as an SL control channel.

(2) SL data channel (physical sidelink shared channel (PSSCH)) may be a resource pool through which the transmitting UE transmits user data. When the SA and SL data are multiplexed and transmitted together in the same resource unit, only the SL data channel except for the SA information may be transmitted in the resource pool for the SL data channel. In other words, resource elements (REs) used to transmit the SA information in individual resource units in the SA resource pool may still be used to transmit the SL data in the resource pool of the SL data channel. For example, the transmitting UE may map the PSSCH to consecutive PRBs and transmit the same.

(3) The discovery channel may be a resource pool used for the transmitting UE to transmit information such as the ID thereof. Through this channel, the transmitting UE may allow a neighboring UE to discover the transmitting UE.

Even when the SL signals described above have the same content, they may use different resource pools according to the transmission/reception properties of the SL signals. For example, even when the SL data channel or discovery message is the same among the signals, it may be classified into different resource pools according to determination of the SL signal transmission timing (e.g., transmission at the reception time of the synchronization reference signal or transmission by applying a predetermined TA at the reception time), a resource allocation scheme (e.g., the BS designates individual signal transmission resources to individual transmitting UEs or individual transmission UEs select individual signal transmission resources within the resource pool), signal format (e.g., the number of symbols occupied by each SL signal in a subframe, or the number of subframes used for transmission of one SL signal), signal strength from a BS, the strength of transmit power of an SL UE, and the like.

### Vehicular Communications for ITS

An intelligent transport system (ITS) utilizing vehicle-to-everything (V2X) may mainly include an access layer, a network & transport layer, a facilities layer, an application layer, security and management entities, etc. Vehicle communication may be applied to various scenarios such as vehicle-to-vehicle communication (V2V), vehicle-to-network communication (V2N or N2V), vehicle-to-road side unit (RSU) communication (V2I or I2V), RSU-to-RSU communication (I2I), vehicle-to-pedestrian communication (V2P or P2V), and RSU-to-pedestrian communication (I2P or P2I). A vehicle, a BS, an RSU, a pedestrian, etc. as the subjects of vehicle communication are referred to as ITS stations.

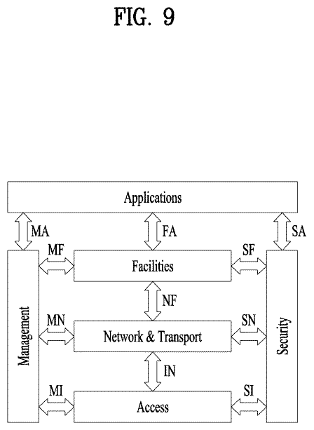

FIG. 9 is a diagram for explaining an ITS station reference architecture.

The ITS station reference architecture may include an access layer, a network & transport layer, a facilities layer, entities for security and management, and an application layer at the top. Basically, the ITS station reference architecture follows a layered OSI model.

Specifically, features of the ITS station reference architecture based on the OSI model are illustrated in FIG. 9. The access layer of the ITS station corresponds to OSI layer 1 (physical layer) and layer 2 (data link layer), the network & transport layer of the ITS station corresponds to OSI layer 3 (network layer) and layer 4 (transport layer), and the facilities layer of the ITS station corresponds to OSI layer 5 (session layer), layer 6 (presentation layer), and layer 7 (application layer).

The application layer, which is located at the highest layer of the ITS station, may actually implement and support a use-case and may be selectively used according to the use-case. The management entity serves to manage all layers in addition to managing communication and operations of the ITS station. The security entity provides security services for all layers. Each layer of the ITS station exchanges data transmitted or received through vehicle communication and additional information for various purposes through an interface. The abbreviations of various interfaces are described below.
MA: Interface between management entity and application layer
MF: Interface between management entity and facilities layer
MN: Interface between management entity and networking & transport layer
MI: Interface between management entity and access layer
FA: Interface between facilities layer and ITS-S applications
NF: Interface between networking & transport layer and facilities layer
IN: Interface between access layer and networking & transport layer
SA: Interface between security entity and ITS-S applications
SF: Interface between security entity and facilities layer
SN: Interface between security entity and networking & transport layer
SI: Interface between security entity and access layer

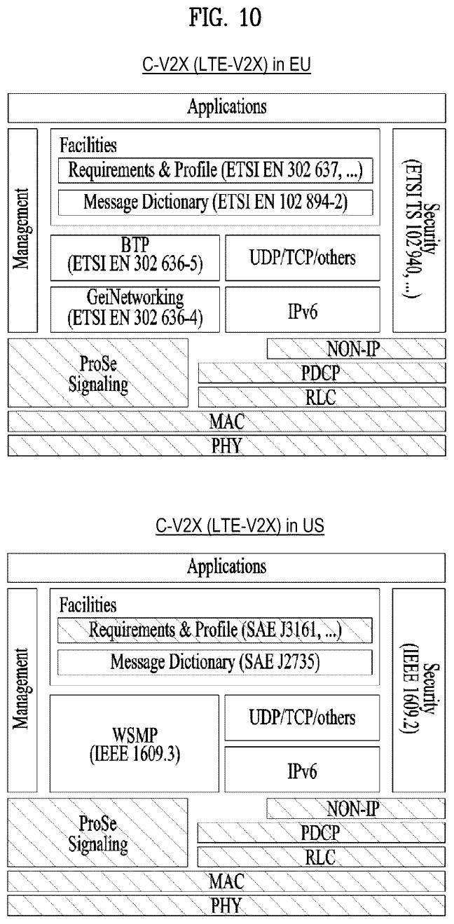

FIG. 10 illustrates an exemplary structure of an ITS station that may be designed and applied based on a reference architecture.

A main concept of the ITS station reference architecture is to allow each layer with a special function to process communication on a layer basis, between two end vehicles/users included in a communication network. That is, when a V2V message is generated, the data is passed through each layer downwards layer by layer in the vehicle and the ITS system (or other ITS-related UEs/systems), and a vehicle or ITS system (or other ITS-related UEs/systems) receiving the message passes the message upwards layer by layer.

The ITS system operating through vehicle communication and the network was organically designed in consideration of various access technologies, network protocols, communication interfaces, etc. to support various use-cases, and the roles and functions of each layer described below may be changed depending on a situation. The main functions of each layer will be briefly described.

The application later actually implements and supports various use-cases. For example, the application layer provides security, efficient traffic information, and other entertainment information.

The application layer controls an ITS station to which an application belongs in various manners or provides services by transferring a service message to an end vehicle/user/infrastructure through the access layer, the network & transport layer, and the facilities layer, which are lower layers of the application layer, by vehicle communication. In this case, the ITS application may support various use-cases. In general, these use-cases may be supported by grouping into other applications such as road-safety, traffic efficiency, local services, and infotainment. Application classification, use-cases, etc. may be updated when a new application scenario is defined. Layer management serves to manage and service information related to operation and security of the application layer, and the related information is transmitted and shared bidirectionally through an MA and an SA (or service access point (SAP), e.g. MA-SAP or SA-SAP). A request from the application layer to the facilities layer or a service message and related information from the facilities layer to the application layer may be delivered through an FA.

The facilities layer serves to support effective implementation of various use-cases defined in an application layer of a higher layer. For example, the facilities layer may perform application support, information support, and session/communication support.

The facilities layer basically supports the 3 higher layers of the OSI model, for example, a session layer, a presentation layer, and the application layer, and functions. Specifically, the facilities layer provides facilities such as application support, information support, and session/communication support, for the ITS. Here, the facilities mean components that provide functionality, information, and data.

The application support facilities support the operation of ITS applications (mainly generation of a message for the ITS, transmission and reception of the message to and from a lower layer, and management of the message). The application support facilities include a cooperative awareness (CA) basic service and a decentralized environmental notification (DEN) basic service. In the future, facilities entities for new services such as cooperative adaptive cruise control (CACC), platooning, a vulnerable roadside user (VRU), and a collective perception service (CPS), and related messages may be additionally defined.

The information support facilities provide common data information or a database to be used by various ITS applications and includes a local dynamic map (LDM).

The session/communication support facilities provide services for communications and session management and include an addressing mode and session support.

Facilities may be divided into common facilities and domain facilities.

The common facilities are facilities that provide common services or functions required for various ITS applications and ITS station operations, such as time management, position management, and service management.

The domain facilities are facilities that provide special services or functions required only for some (one or more) ITS applications, such as a DEN basic service for road hazard warning applications (RHW). The domain facilities are optional functions and are not used unless supported by the ITS station.

Layer management serves to manage and service information related to the operation and security of the facilities layer, and the related information is transmitted and shared bidirectionally through an MF and an SF (or MF-SAP and SF-SAP). The transfer of service messages and related information from the application layer to the facilities layer or from the facilities layer to the application layer is performed through an FA (or FA-SAP), and bidirectional service messages and related information between the facilities layer and the lower networking & transport layer are transmitted by an NF (or NF-SAP).

The network & transport layer servers to configure a network for vehicle communication between homogenous or heterogeneous networks through support of various transport protocols and network protocols. For example, the network & transport layer may provide Internet access, routing, and vehicle networking using Internet protocols such as TCP/UDP+IPv6 and form a vehicle network using a basic transport protocol (BTP) and GeoNetworking-based protocols. In this case, networking using geographic position information may also be supported. A vehicle network layer may be designed or configured depending on technology used for the access layer (access layer technology-independently) or regardless of the technology used for the access layer (access layer technology-independently or access layer technology agnostically).

Functionalities of the European ITS network & transport layer are as follows. Basically, functionalities of the ITS network & transport layer are similar to or identical to those of OSI layer 3 (network layer) and layer 4 (transport layer) and have the following characteristics.

The transport layer is a connection layer that delivers service messages and related information received from higher layers (the session layer, the presentation layer, and the application layer) and lower layers (the network layer, the data link layer, and the physical layer). The transport layer serves to manage data transmitted by an application of the ITS station so that the data accurately arrives at an application process of the ITS station as a destination. Transport protocols that may be considered in European ITS include, for example, TCP and UDP used as legacy Internet protocols, and there are transport protocols only for the ITS, such as the BTS.

The network layer serves to determine a logical address and a packet forwarding method/path, and add information such as the logical address of a destination and the forwarding path/method to a header of the network layer in a packet received from the transport layer. As an example of the packet method, unicast, broadcast, and multicast between ITS stations may be considered. Various networking protocols for the ITS may be considered, such as GeoNetworking, IPv6 networking with mobility support, and IPv6 over GeoNetworking. In addition to simple packet transmission, the GeoNetworking protocol may apply various forwarding paths or transmission ranges, such as forwarding using position information about stations including vehicles or forwarding using the number of forwarding hops.

Layer management related to the network & transport layer serves to manage and provide information related to the operation and security of the network & transport layer, and the related information is transmitted and shared bidirectionally through an MN (or MN-SAP) and an SN (or SN-SAP). Transmission of bidirectional service messages and related information between the facilities layer and the networking & transport layer is performed by an NF (or NF-SAP), and service messages and related information between the networking & transport layer and the access layer are exchanged by an IN (or IN-SAP).

A North American ITS network & transport layer supports IPv6 and TCP/UDP to support existing IP data like Europe, and a wave short message protocol (WSMP) is defined as a protocol only for the ITS.

A packet structure of a wave short message (WSM) generated according to the WSMP includes a WSMP header and WSM data carrying a message. The WSMP header includes Version, PSID, WSMP header extension fields, WSM WAVE element ID, and Length.

Version is defined by a WsmpVersion field indicating an actual WSMP version of 4 bits and a reserved field of 4 bits. PSID is a provider service identifier, which is allocated according to an application in a higher layer and helps a receiver to determine an appropriate higher layer. Extension fields is a field for extending the WSMP header, and includes information such as a channel number, a data rate, and transmit power used. WSMP WAVE element ID specifies the type of a WSM to be transmitted. Length specifies the length of transmitted WSM data in octets through a WSMLength field of 12 bits, and the remaining 4 bits are reserved. LLC Header allows IP data and WSMP data to be transmitted separately and is distinguished by Ethertype of a SNAP. The structures of the LLC header and the SNAP header are defined in IEEE802.2. When IP data is transmitted, Ethertype is set to 0x86DD in the LLC header. When WSMP is transmitted, Ethertype is set to 0x88DC in the LLC header. The receiver identifies Ethertype. If Ethertype is 0x86DD, the receiver transmits upward the packet to an IP data path, and if Ethertype is 0x88DC, the receiver transmits upward the packet to a WSMP path.

The access layer serves to transmit a message or data received from a higher layer on a physical channel. As access layer technologies, ITS-G5 vehicle communication technology based on IEEE 802.11p, satellite/broadband wireless mobile communication technology, 2G/3G/4G (long-term evolution (LTE), etc.)/5G wireless cellular communication technology, cellular-V2X vehicle-dedicated communication technologies such as LTE-V2X and NR-V2X (new radio), broadband terrestrial digital broadcasting technology such as DVB-T/T2/ATSC3.0, and GPS technology may be applied.

A data link layer is a layer that converts a physical line between adjacent nodes (or between vehicles) with noise into a communication channel without transmission error, for use in the higher network layer. The data link layer performs a function of transmitting/delivering/forwarding L3 protocols, a framing function of dividing data to be transmitted into packets (or frames) as transmission units and grouping the packets, a flow control function of compensating for a speed difference between a transmitter and a receiver, and a function of (because there is a high probability that an error and noise occurs randomly in view of the nature of a physical transmission medium) detecting a transmission error and correcting the error or detecting a transmission error based on a timer and an ACK signal by a transmitter in a method such as automatic repeat request (ACK) and retransmitting a packet that has not been correctly received. In addition, to avoid confusion between packets or ACK signals, the data link layer performs a function of assigning a sequence number to the packets and the ACK signals, and a function of controlling establishment, maintenance, and disconnection of a data link between network entities, and data transmission between network entities. The main functions of logical link control (LLC), radio resource control (RRC), packet data convergence protocol (PDCP), radio link control (RLC), medium access control (MAC), and multi-channel operation (MCO) included in the data link layer will be described below.

An LLC sub-layer enables the use of different lower MAC sub-layer protocols, and thus enables communication regardless of network topology. An RRC sub-layer performs functions such as broadcasting of cell system information required for all UEs within a cell, management of delivery of paging messages, management (setup/maintenance/release) of RRC connection between a UE and an E-UTRAN, mobility management (handover), transmission of UE context between eNodeBs during handover, UE measurement reporting and control therefor, UE capability management, temporary assignment of a cell ID to a UE, security management including key management, and RRC message encryption. A PDCP sub-layer may performs functions such as IP packet header compression in a compression method such as robust header compression (ROHC), cyphering of a control message and user data, data integrity, and data loss prevention during handover. RLC sub-layer delivers a packet received from the higher PDCP layer in an allowed size of the MAC layer through packet segmentation/concatenation, increases data transmission reliability by transmission error and retransmission management, checks the order of received data, reorders data, and checks redundancy. A MAC sub-layer performs functions such as control of the occurrence of collision/contention between nodes for use of shared media among multiple nodes, matching a packet delivered from the higher layer to a physical layer frame format, assignment and identification of the address of the transmitter/receiver, detection of a carrier, collision detection, and detection of obstacles on the physical medium. An MCO sub-layer enables efficient provision of various services on a plurality of frequency channels. The main function of MCO sub-layer is to effectively distribute traffic load of a specific frequency channel to other channels to minimize collision/contention of communication information between vehicles in each frequency channel.

The physical layer is the lowest layer in the ITS layer architecture. The physical layer defines an interface between a node and a transmission medium and performs modulation, coding, and mapping of a transport channel to a physical channel, for bit transmission between data link layer entities and informs the MAC sub-layer of whether a wireless medium is busy or idle by carrier sensing or clear channel assessment (CCA).

A Soft V2X system may be a system in which a Soft V2X server receives a VRU message or a personal safety message (PSM) from a vulnerable road user (VRU) or a V2X vehicle and transfers information on a neighbor VRU or vehicle based on the VRU message or the PSM message or may analyze a road condition, etc. on which neighbor VRUs or vehicles move and may transmit a message informing a neighbor VRU or vehicle of a collision warning, etc. based on the analyzed information (e.g., through a downlink signal) via V2X communication using a UU interface. Here, the VRU message may be a message transmitted to the Soft V2X server through the UU interface, and may include mobility information about the VRU, such as a position, a movement direction, a movement path, and a speed of the VRU. That is, the Soft V2X system may use a method of receiving mobility information of VRUs and/or vehicles related to V2X communication through the UU interface and controlling a driving route or a VRU movement flow of the VRU, etc. based on the mobility information received by the Soft V2X server, such as a network. The Soft V2X system may be configured in relation to V2N communication.

User equipment or pedestrian equipment (VRU device) that is difficult to perform direct communication (PC5, DSRC) related to V2X communication can provide or receive driving information and mobility information to nearby vehicles or VRUs through the Soft V2X system based on the UU interface. Through this, the user equipment or pedestrian equipment (VRU device) that is difficult to perform the direct communication (PC5, DSRC) can be protected from surrounding vehicles.

### Method of Adjusting Message Processing Priority in Consideration of V2X Message Processing Time Interval

According to the current V2X standards, a UE may periodically transmit an awareness message including UE status information to surrounding UEs. These awareness messages may include basic safety message (BSM) and common awareness message (CAM), and vulnerable road user (VRU) information such as personal safety messages (PSM) and VRU awareness messages (VAM), and a message (collective perception message (VAM)) including the UE status information generated using sensing information of other UEs may also be transmitted to surrounding UEs on a broadcast basis. For example, in the case of BSM, each UE/vehicle is recommended to transmit a periodic safety message at an interval 100 ms to surrounding UEs within 300 m. When the density of UEs increases, such as in a densely populated area, if excessive network traffic occurs in a network, the probability of packet collisions and message transmission failures increases, which may result in data processing delays. In this case, a congestion control algorithm that considers channel busy percentage (CBP) may be performed to appropriately adjust a message transmission interval and transmission power, thereby improving packet delivery ratio (PDR) performance.

Conventionally, the PDR performance itself may be improved through a congestion control algorithm in transmitting a V2X message, but a situation may arise in which processing and verification of all received messages are not performed smoothly depending on a filtering condition or the like of a reception UE. For example, there may be a subsequent processing procedure that verifies a certificate chain of a signed message and processes encrypted information to verify the validity of information included in the message at the reception UE, and when the amount of messages accumulated in a buffer of the reception UE is large, a proportion of messages that are not processed up to the subsequent processing procedure may increase. In this case, a message verification rate may be lowered compared to a message reception rate, or a problem of message processing omission may occur. Due to the problem of a verification rate and/or processing omission, a problem may occur in that a road hazard situation is not timely determined/recognized based on a received message. For example, the reception UE may adjust/change a priority for processing the message in consideration of a processing and verification time interval of a received V2X message. Here, processing and verification of the received message may include all subsequent processing procedures for the received message (certificate verification, encrypted information processing, and validity analysis of the included information). Conventionally, a transmission UE may adjust a broadcast message transmission cycle and transmission power through a congestion control algorithm and transmit the message, and the reception UE may receive a message that exceeds the processing capability/ability of the reception UE. To address this situation, a method of selectively processing or filtering a received message by the reception UE may be performed.

The received message is stored in a buffer of a UE (or V2X UE) and is sequentially processed and verified. The received message may have various subsequent processing operations (or, processing operation of the message). Examples of subsequent processing operations may include certificate chain verification for a signed message and verification of the validity of UE information contained in the encrypted information, and additional time may be required for each subsequent processing operation. Even if a method is applied to adjust a level of a message transmission-related parameter through a congestion control algorithm for the transmission UE, the reception UE may not process all received messages.

Typically, an on-board unit (OBU) device does not prioritize messages and processes the messages by using a single first-in-first-out (FIFO) method in a network and a transport layer. Various researches have proposed sampling/filtering methods for a message processed by a reception UE. For example, last-in-first-output (LIFO) has been proposed as a method of first checking a new message, a method of randomly selecting a message in a buffer (serve-in-random-order (SIRO)), a method of collecting a message for a certain period of time and checking all messages at once, and the like. More recently, a method has been proposed to adjust message processing priorities based primarily on information from the transmission UE. For example, a method of adjusting the message processing priority based on information of a transmission UE may be a method of reducing a processing priority of the received message as the transmission UE of the received message is farther away from the reception UE (or, the transmission UE is a UE moving in an opposite direction). Alternatively, the method of adjusting the message processing priority based on the information of the transmission UE may additionally consider information on a road structure such as presence of barriers (median strips or fences) for physical separation on the road, and accident probability information calculated by taking into account a relative speed and distance of the UEs.

In general, research has been proposed on distance-based message filtering by the reception UE. In detail, among the messages received from a plurality of transmission UEs, processing of at least one received message is continuously missed or delayed due to various factors (congestion, message filtering conditions of the reception UE (priority processing of information from nearby UEs)). In this case, a service level requirement required by a V2X service is not required or an unexpected risk occurs. The proposed method below may additionally consider a processing and verification time interval for messages received from the same UE among the received messages for each transmission UE. For example, a reception UE may periodically receive a message from a specific UE, and the reception UE may increase a priority (or increase a weight of a priority) of a message periodically received for the specific transmission UE when the message has not been processed for a relatively long time or above a threshold value from a time when processing and/or verification of the message of the specific transmission UE is completed. The reception UE may adjust a weight of the priority by further considering the processing capability of the reception UE and processed message information (status information of the transmission UE or type of message). When a basic message processing scheduling method of the reception UE is applied, a priority adjusting method based on the proposed processing/verification time interval may be selectively applied depending on a current processing capability and congestion level of the reception UE. The method of processing the received message may be a basic message processing scheduling method (e.g., FIFO, LIFO, and SIRO) that does not consider information (location or direction) of the transmission UE. The basic scheduling method has a limitation in that it is difficult to process all messages in congested situations with high vehicle density. There is a method of assigning message processing priorities by considering various factors (such as close distance or high probability of accident occurrence) estimated based on information from the transmission UE. Even in this case, packets may be continuously missed or lost due to the priority assignment rules for message processing, or processing of consecutive messages from the same UE may be delayed. BSM may transmit while increasing the DE_MsgCount value by 1, and information loss or delay may be determined through the continuity of the DE_MsgCount value of the BSM received and processed by the same UE. Considering these points, a new message filtering method needs to be proposed to satisfy the minimum conditions (communication range, reliability, or latency) required for V2X services while recognizing information between UEs in a timely manner.

This proposed method may reduce an information loss rate caused by omission due to the existing message filtering condition set for the reception UE, and prevent dangerous situations that occur due to failure to recognize unexpected path changes due to a large processing time interval of the reception UE. Hereinafter, the proposed method described above is explained in detail.

Hereinafter, a method of performing a processing filtering operation of a received message based on a time interval between processed messages or a decoding time interval of the messages.

Hereinafter, applying/adding a priority weight in determining a priority may be a process/operation of setting a relatively higher priority than the existing priority. For example, when a specific value considered in a method of determining the existing priority decreases (e.g., closer in distance) and has a higher priority, applying/adding a priority weight in determining the priority may be interpreted as adding a negative priority weight to the specific value (or subtracting a priority weight from the value) to relatively increase the priority compared to the existing priority. Alternatively, when a specific value considered in a method of determining a priority decreases (e.g., higher QoS/PQI) and has a higher priority, applying/adding a priority weight in determining the priority may mean increasing the priority by adding (summing) the priority weight to the specific value. Therefore, increasing a priority weight below may mean increasing a weight to have a higher priority than the priority according to application of the existing priority weight, and decreasing a priority weight may mean decreasing a weight to have a lower priority than the priority according to application of the existing priority weight.

According to the current V2X communication standards, the UE may periodically transmit safety or awareness messages including UE status information to surrounding UEs. For example, a vehicle/UE may transmit BSM, CAM, or the like and also transmit a message (CPM) including the UE status information generated using VRU information, PSM, VAM, and sensing information of other UEs to surrounding UEs on a broadcast basis. For example, in the case of BSM, each UE/vehicle is recommended to transmit a periodic safety message at an interval of 100 ms to surrounding UEs within 300 m (a transmission interval, transmission power, and the like may be controlled according to a congestion control algorithm). Even if a message is transmitted based on the congestion control algorithm, it may take a certain time for the reception UE to perform subsequent processing of the received message. Therefore, if the amount of messages accumulated in a buffer of the reception UE exceeds the processing capacity of the reception UE, a problem of message loss/delay may occur due to processing delay/omission of some of the received messages. The processing and verification procedure for the received message may include decoding a message, certificate chain verification for the signed message, processing encrypted information, and analyzing the validity of information included in the message.

To resolve this problem of loss/delay of received messages, the reception UE needs to perform message sampling/filtering by determining a message processing priority. In general, the reception UE may determine the processing/verification priority for the received message by considering the location and direction information of the transmission UE included in the message. For example, the further away a transmission UE is from the current location of the reception UE or the further away a transmission UE is from the current location of the reception UE or the further away a transmission UE is from the current location of the reception UE, the lower the priority given to processing of the message of the transmission UE. Here, in the case of a road physically separated in up and down directions due to a median strip, fence, and the like, the reception UE may lower a priority of a message from a transmission UE moving in an opposite direction. The reception UE may adjust/change a priority of the message of the transmission UE by considering not only the location information but also the possibility of collision (Time to Collision) by using the moving speed of the transmission UE and a distance information between the transmission UE and the reception UE.

However, when only relative location information between the transmission UE and the reception UE is considered, if there are many UEs in the vicinity and it is crowded, only messages from transmission UEs that are close to each other are processed in a short period of time, and processing/verification of messages from transmission UEs that are located at a certain distance or more may be omitted or discarded, or a processing/verification time of messages from transmission UEs that are located at a certain distance or more may be delayed. In this case, processing of the received message may not be performed in a timely manner, which may result in the reception UE not being able to properly recognize an important or dangerous situation.

To prevent occurrence of such a problem situation, the reception UE may adjust/change a priority of the message by additionally considering a processing time interval for messages (periodically) received from the same UE. Here, the message processing may include all message subsequent processing procedures, such as decoding of the received message, certificate verification, encrypted information processing, and validation of included information, as described above. In detail, the reception UE may adjust a priority of the periodically received message based on a processing/verification time interval for the messages periodically received from the same transmission UE when the message basic processing method of the existing UE is applied. For example, if the processing time interval of a message periodically received from a specific transmission UE exceeds a preset threshold, the reception UE may further include the processing time interval of the message in the parameters for determining the priority of the message basic processing algorithm for each transmission UE (e.g., FIFO, LIFO, Batch method, application of priority rules according to distance or risk), and may add a weight to determination of the priority such that the processing time interval of the message may increase. Here, the preset threshold value may be set differently depending on the characteristics of the received message/information and the related V2X service. For example, the preset threshold value may be preset based on the transmission/reception cycle of the received message, requirements of the V2X service, and the like. The message filtering/message prioritization method based on the processing time interval of the message is as follows.
1. Store received messages in buffer of reception UE
2. Perform message processing based on basic message processing method/condition of reception UE
3. When processing time interval between messages received from the same UE is greater than or equal to [x] ms, message processing priority weighting is applied.
4. Adjust pre/post message weights and threshold values (x) according to processing capability and processed message information of UE
5. Delete/discard messages from buffer when processing delay is greater than or equal to [y] ms

As described above, the processing priority of the message needs to be adjusted by comprehensively considering the status information of the transmission UE, a type of message, and a processing time interval of the received message. A preset threshold value (x) for the processing time interval of the message may be flexibly adjusted depending on the importance or priority of the received message. For example, the threshold value (x) may be set to a low value such that status information of the transmission UE, such as the speed of the transmission UE, may be considered or the processing priority of the message may be set high for the type of message with high importance, and the like, and the minimum message processing interval for such messages may be reduced. Alternatively, the threshold value (x) may be set to a high value such that the processing priority of the message may be set low for the types of messages having low importance (e.g., based on the risk of collision with the transmission UE), and the minimum message processing interval for such messages may be increased.

Here, the following parameters may be considered to adjust a threshold (x) for the processing time interval of the received message or a deletion condition (y) for the message stored in the buffer.
a) Message reception rate vs. processing rate: A ratio of the number of messages stored in the buffer that have been processed
b) Message processing delay: (current time-message generating time)
c) Packet loss rate: A percentage of packets that are dropped after exceeding the specified lifetime among the messages stored in the buffer.
d) Channel congestion (CBR)

The reception UE may adjust/change a threshold for message processing priority/filtering operation conditions/message deletion conditions through the parameters described above.

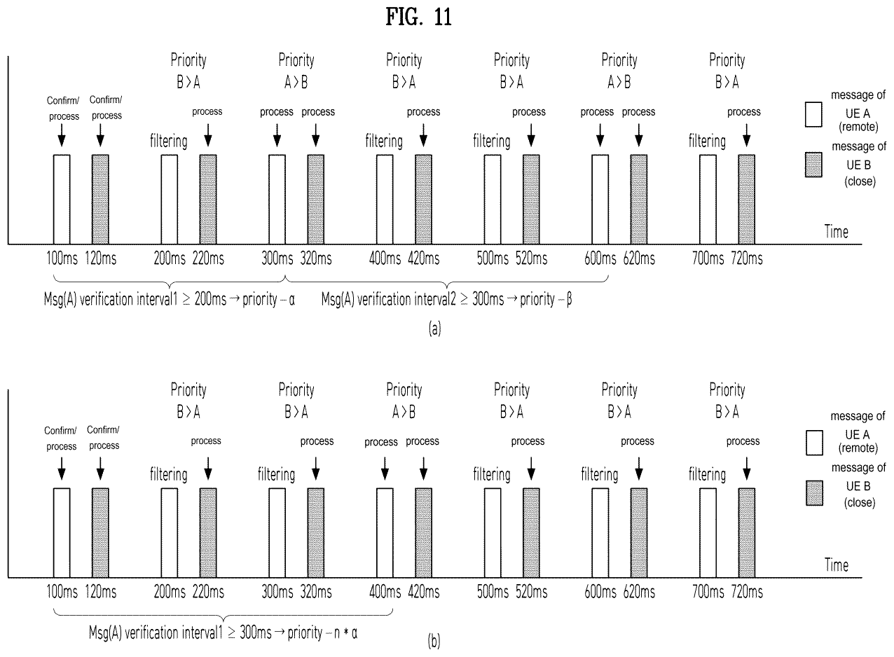

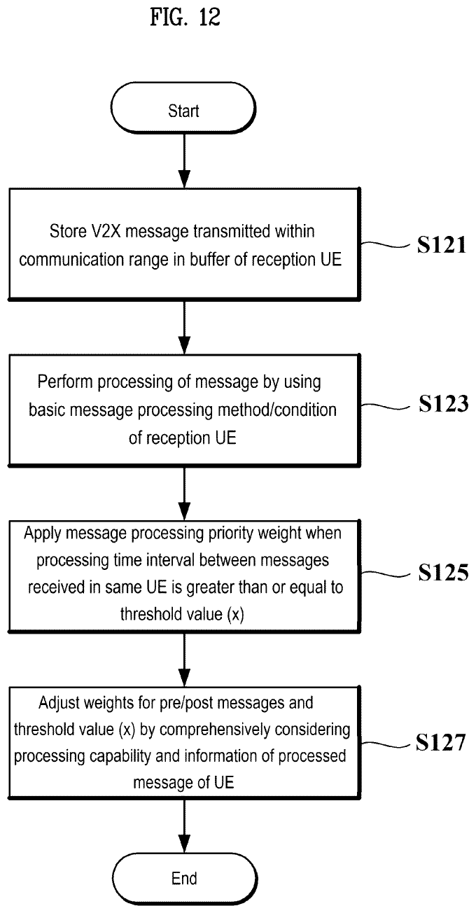

FIG. 11 and FIG. 12 are diagrams for explaining a method of determining a processing priority of a message based on a processing time interval of a message.

Referring to FIG. 11(a), a transmission UE A and a transmission UE B may periodically transmit messages at the same cycle of 100 ms. The transmission UE may periodically receive messages from a relatively closer transmission UE B at a time point of 120 ms, 220 ms, 320 ms, 420 ms, 520 ms, 620 ms, and 720 ms, and may periodically receive messages from a relatively farther transmission UE A at a time point of 100 ms, 200 ms, 300 ms, 400 ms, 500 ms, 600 ms, and 700 ms. In this case, the threshold [x] for the processing time interval of the message may be set to 200 ms (by consideration of a transmission cycle of a message).

In this case, the reception UE may preferentially process all messages because messages from the transmission UE B and the transmission UE A, which are received at 100 ms/120 ms, are new messages. Then, the reception UE may preferentially process the message of the transmission UE B, received at 220 ms, over the message of the transmission UE A, received at 200 ms, according to a distance-based priority determination method. In this case, the reception UE may not process or discard the message of the transmission UE A due to insufficient processing capability of the received messages. Then, the transmission UE A is relatively further away from the transmission UE B, and thus the reception UE may have a lower priority for the message of the transmission UE A, received at 300 ms than for the message of the transmission UE B, received at 320 ms, but a processing delay time/processing time interval of the message for the tA exceeds 200 ms, and thus a first weight (α) may be applied to a processing priority of the message of the transmission UE A (priority-α). Alternatively, the reception UE may increase a priority of the message of the transmission UE A by subtracting a first weight (α) from a distance value with respect to the transmission UE A. As such, by applying/adding priority weights, a processing priority of the message of the transmission UE A may be increased compared to the received messages from other transmission UEs, and thus the reception UE may process the message of the transmission UE A received at 300 ms with priority over the remaining messages, unlike the case in which the message of the transmission UE A received at 200 ms is omitted/discarded (in this case, processing of other messages (messages of transmission UE B and transmission UEs other than transmission UE A) may be delayed or discarded). After 300 ms, the reception UE may process a message of the transmission UE A by reverting to the existing message processing priority algorithm based on a default distance. As shown in FIG. 11(a), in the case of a message of the transmission UE A received at 600 ms, the processing time interval of the message of the transmission UE A is 300 ms or more, and thus the reception UE may apply a second weight (β) to a priority of the message of the transmission UE A (priority-β). Alternatively, the reception UE may increase a priority of the message of the transmission UE A by subtracting a second weight (β) from a distance value with respect to the transmission UE A. Here, the weight may increase as the processing time interval of the message increases, and thus the second weight (β) may be greater than the first weight (α).

Alternatively, when a message of the transmission UE A received at 300 ms is processed, the reception UE may adjust the processing priority weight for the message before/after receiving the message of the transmission UE A based on the information included in the processed message of the transmission UE A. For example, in the case of a message that is filtered and stored later in the buffer of the reception UE, such as a message from the transmission UE A received at 200 ms, a processing priority of the message is generally adjusted to low because the message received at a later point in time (300 ms) is processed, but when it is determined that confirmation of message information is necessary, additional confirmation may be performed. Alternatively, the reception UE may adjust the weight for the parameter related to the processing time interval depending on whether the processing capability of the reception UE is low or the information of the transmission UE is determined to be unnecessary.

For example, referring to FIG. 11(b), when the current processing capability of the reception UE is insufficient, the reception UE may confirm that a distance from the transmission UE A gradually increases through processing of messages received from the transmission UE A at 100 ms and 300 ms. In this case, the reception UE may increase the threshold value (x) for the transmission UE A by adjusting the threshold weight for determining the threshold value (x) for the transmission UE A. For example, by increasing the threshold value (x), the reception UE may process a message for the transmission UE A at 600 ms after processing the message of the transmission UE A at 300 ms. The reception UE may delete/discard messages that have a processing delay time greater than or equal to a certain time among the messages stored in the buffer.

Alternatively, the reception UE may not be capable of processing the message from the transmission UE A received at 300 ms, even though the reception UE has insufficient processing capability or the (default) priority weight is assigned according to a default message processing priority algorithm. In this case, the reception UE may increase a default priority weight for the message of the transmission UE A.

For example, as illustrated in FIG. 11(b), although the processing time interval for the message of the transmission UE A received at 300 ms exceeds 200 ms, the message of the transmission UE A received at 300 ms may still be filtered due to insufficient processing capability of the reception UE and priority processing of messages of other surrounding UEs and the message of the transmission UE B. In this case, the message processing time interval for the message of the transmission UE A received at 400 ms has passed 300 ms, and thus the reception UE may further increase the priority weight of the message of the transmission UE A. The increased priority weight may temporarily increase a processing priority of messages from the transmission UE A compared to those from the transmission UE B. In this case, the reception UE may process the message of the transmission UE A received at 400 ms with priority over the message of the transmission UE B received at 420 ms. Based on the information contained in the message of the transmission UE A received at 400 ms, the reception UE may adjust the weight for the priority applied to the message of the transmission UE A to the default priority weight.

The proposed method described above has been explained based on an example of a situation in which messages are received from two transmission UEs for convenience of explanation, but a situation in which messages received from a large number of UEs are stored in a buffer in a congested situation may also be assumed.

Referring to FIG. 12, the reception UE may store the V2X message transmitted within a communication range in a buffer (S121). The reception UE may process the V2X message stored in the buffer by using a preset message processing method/condition (S123). The reception UE may additionally add a priority weight (or a preset default priority weight) in determining a processing priority for a message of the specific transmission UE when the processing time interval between messages periodically received in the specific transmission UE is greater than or equal to a threshold value (x) (S125). The received V2X message may process V2X messages stored in the buffer according to the determined processing priority, and may discard some of the V2X messages stored in the buffer without processing based on the processing capability of the reception UE. Then, the reception UE may adjust the priority weights for the pre/post messages and the threshold value (x) by considering its processing capability and information of the processed message (S127).

The proposed method described above may minimize message/information loss (PER) that is omitted by the basic message processing algorithm by adjusting priority/priority weights that additionally consider the time interval between messages processed for respective transmission UEs, and may minimize/avoid a risk situation that occurs due to failure to recognize unexpected path changes of a specific UE due to a large processing time interval of messages for specific UEs. Here, there may be exceptional circumstances in which very important or urgent V2X information or messages need to be processed regardless of priority. For example, the urgent V2X information includes road event information that occurs in the vicinity of the reception UE, warning information for a situation with a high probability of an accident, and emergency vehicle information. The proposed method described above is described based on a broadcast message transmitted by a UE for convenience of explanation, but may be applied regardless of the cast method (unicast, broadcast, and groupcast) and communication method (short range communication, and long range communication) of the received message.

When the at least one message described above is a message related to a SoftV2X service, a network or server providing the SoftV2X service may receive at least one message related to V2X from at least one transmission UE, such as the reception UE described above. In this case, the network or server may perform the operation described above related to a processing priority for the received message of the reception UE. That is, the reception UE described above may be replaced by a network/server, and operations related to the processing priority described above may be applied.

Hereinafter, a method of determining processing priorities between messages with different message types is described in detail.

### Method of Adjusting Processing Priorities for Different Types of V2X Messages

Various V2X services have been developed and provided to support V2X applications for road users. V2X services may improve road safety or traffic operation efficiency, and to provide V2X services, it is necessary to receive and process/analyze messages transmitted from various objects (vehicles, VRUs, RSUs, servers, and the like) such as UE status information, surrounding environment information, and event information. Standard organizations such as 3GPP define communication requirements for various V2X services, and maintaining stable communication performance and data throughput is important to satisfy these minimum requirements. When factors that degrade V2X communication performance, such as high vehicle density or a problem with the communication channel, occur, the transmission UE may control a transmission cycle or transmission power of the message based on a congestion control algorithm to increase a packet transmission success rate related to the message.

A priority weight described below is a weight used to determine a processing priority between messages of different message types, and is a weight that is distinct from the priority weight defined to determine the processing priority between messages of the same message type in the “Method for adjusting message processing priority considering V2X message processing time interval.”

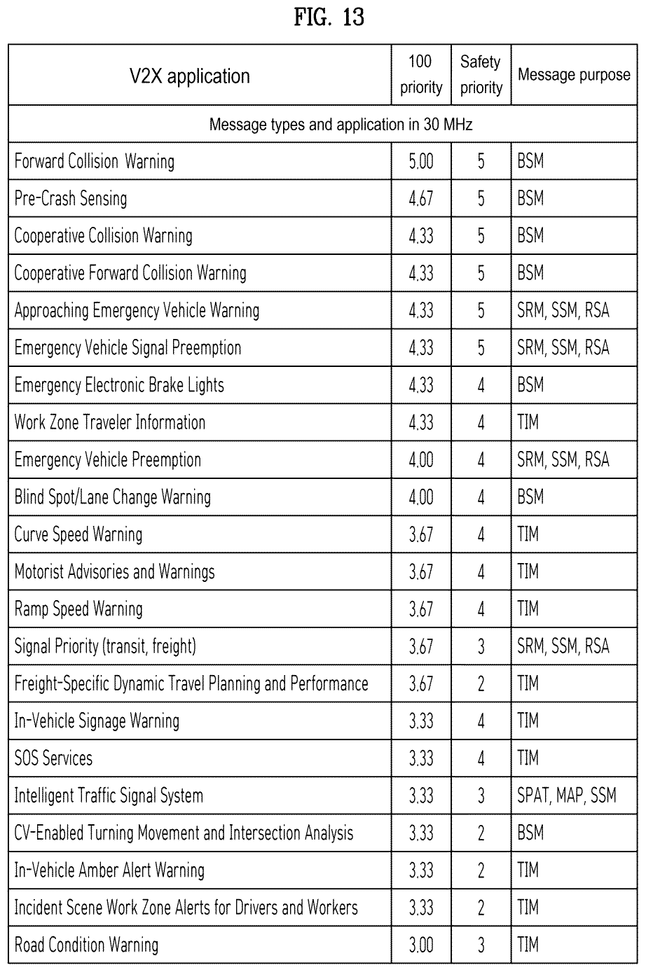

FIG. 13 is a diagram for explaining transmission priorities by message type.

In detail, a method of controlling information generation and transmission performance by considering a priority level of messages transmitted from a transmission UE is also currently considered. For example, in PC5 V2X communication, the UE may differentiate Quality of Service (QoS) for each packet through ProSe Per Packet Priority (PPPP) and transmit packets with higher priority first. Alternatively, in Uu V2X, V2X message transmission QoS may be managed by considering Quality Class Indicator (QCI) and the like. A method of controlling message transmission performance according to the application type of the message is currently considered in consideration of the importance and priority level of the service, and the like, obtained by considering the safety benefits of the V2X service.

For example, referring to FIG. 13, priorities may be defined for each V2X service/message type. The transmission priority of messages may be adjusted for each service/message type based on the priority of each V2X service/message type.

To manage the QoS of V2X applications and maintain a stable communication channel environment, various measures are currently applied to a transmission stage. For example, as described above, a method is currently applied to control a transmission cycle and/or power of a message by considering the level of congestion of the communication channel for the transmission UE. There is a method to adjust PPPP per packet to transmit high priority packets first. Alternatively, V2X services may be implemented and provided based on various communication methods (Long/Short range communication) and V2X messages received from UEs (or vehicles, VRUs, RSUs, servers, and the like). Conventionally, to maintain a stable communication channel environment and manage the QoS of V2X services, a transmission method of controlling a transmission power and transmission cycle through a congestion control algorithm at a message transmission stage or consider packet-by-packet priority are applied.

However, despite the application of various methods in the transmission stage, there is a lack of treatment of message processing methods in a reception stage. For example, when a reception UE receives all different types of messages transmitted from various types of transmitting UEs (or vehicles, VRUs, RSUs, servers, or the like) in a complex environment in which the delay spread of a communication channel varies, a situation may arise in which it is difficult to process all messages and information due to the load on the reception UE. Typically, a reception UE processes received messages sequentially (in the receiving order), and it may take some time for subsequent processing (decoding, validation, and the like) of received messages. In this case, there may be a limit to the amount of messages that are to be processed at one time by the reception UE. That is, it is difficult for the reception UE to maintain a stable data processing volume when a certain amount of messages are received. In this situation, to maintain the target data processing capacity and service quality of the current reception UE, there is a need to apply and implement an efficient message processing algorithm in terms of the reception UE.

In detail, when different types of messages are received from various transmission UEs (or vehicles, VRUs, RSUs, servers, or the like), the reception UE may set/determine the processing priority of the received message by considering the status of the reception UE and information included in the received message, and a method of flexibly adjusting the priority weight related to the determination of the priority may be considered. Here, adjustment of message processing priority may be related to the order of subsequent processing (e.g., certificate verification, encrypted information processing, validity verification of included information, and the like) after checking basic information about received messages (status information, type of included information). In general, V2X messages may be transmitted with a controlled transmission cycle or transmission power during the transmission stage, or transmitted according to priority. Nonetheless, in a complex environment in which the delay spread of a communication channel changes, when different types of messages transmitted from various types of UEs (vehicles, VRUs, RSUs, servers, and the like) are all received by a reception UE, a situation may arise in which the reception UE may not process all of the received messages. Therefore, the final V2X service is provided based on the information of the received message at the reception UE, and thus the reception UE may need an algorithm that may appropriately process or filter the received message to maintain the target data throughput and service quality of the current reception UE. Hereinafter, a method of managing the QoS of V2X services and improving the overall quality of V2X services through adjusting processing priorities based on an algorithm for appropriately processing/filtering received messages of different message types.

When receiving different types of V2X messages, the reception UE may dynamically adjust the message processing priority based on the processing capability of the current reception UE and information in the received message. In detail, based on conditions such as the processing capability and load level of the reception UE, the reception UE may determine whether to apply/operate the message processing algorithm. The reception UE may determine the order of subsequent processing of messages by dynamically adjusting the priority weights for information/message currently required by the UE according to the UE, environment, road conditions, and the like while applying a fixed priority for each received message. Here, subsequent processing of a message may mean an operation of verifying a certificate related to the received message, processing encrypted information, validating the included information, and the like after confirming basic information about the received message (status information, type of included information).

Conventionally, V2X services existed for various purposes such as traffic safety and traffic efficiency improvement, and in a situation in which the processing capability of the UE is insufficient and different types of messages are accumulated, the reception UE may determine the importance of a message and adjust the processing priority. To this end, a fixed priority may be set as a measure of importance for each message type. The reception UE may refer to the priority defined in the message transmission stage or calculate/determine the processing priority through methodologies such as expert research, service safety gain analysis, and QoS prediction. For example, fixed priorities for V2X service-related messages may be defined as shown in Table 5 below. Here, fixed priorities may be set/updated based on traffic characteristics of the road, and the like.

TABLE 5

| Priority | Service | Message |
|---|---|---|
| 1 | Safety service | DENM, Critical BSM/CAM/ |
| | | PSM/VAM/SDSM (Sensor |
| | | Data Sharing Message)/ |
| | | CPM, EVA (Emergency |
| | | Vehicle Alert), etc. |
| 2 | Safety service | RSM (Roadside Safety |
| | (Infra only) | Message), Critical PVD |
| | | (Probe Vehicle Data), etc. |
| 3 | Sensor data sharing | SDSM, CPM, etc. |
| 4 | Essential service | BSM, CAM, PSM, VAM, MSCM, etc. |
| 5 | Essential (infra only) | SPaT, MAP, etc. |
| 6 | Mobility/Info. service | PVD, TIM, RWM, IVIM, etc. |

The reception UE may dynamically adjust a priority of a required service or processing message by comprehensively considering various information such as the status of the reception UE (location, direction, and the like), road (type), traffic conditions, and type of received message. The reception UE may adjust the processing priority between different types of messages according to the following algorithm. Here, parameters for adjusting the adaptive priority per message may be added or omitted.
1. Start of message processing algorithm operation according to conditions of the reception UE: When a processing volume level of the reception UE is less than or equal to x (0 to 100) % compared to the amount of messages received, the message processing algorithm may be applied/operated.
2. Applying fixed priorities per message: The reception UE may apply fixed priorities for processing per application/message.
3. Adjusting the adaptive priority per message: The reception UE may adjust the priority per message (by applying priority weights) by comprehensively considering the following circumstances/parameters, and the like.
A. Consider repeated data processing: A separate messages including the same (or almost unchanged) status information messages that occur more than a certain number of times or that contain the same information as information detected and included in sensors such as SDSM and CPM may be filtered or have their processing priority weights reduced.
B. Consider information included in sensor sharing messages: When a high proportion of objects detected in sensor sharing messages are vehicles, VRUs, and the like without V2X communication capabilities, the weighting of the processing priority of the received message may increase.
C. Consider path prediction information: A weight of a processing priority for a received message that has a higher correlation (than a predetermined threshold) with a predicted movement path of the reception UE may be increased, and the weight of the processing priority for the received message that has a lower correlation (than a predetermined threshold) with the predicted movement path of the reception UE may be decreased.
D. Consider risk level: When a severity level of the event that occurs is higher (than a critical risk level) or a correlation (distance, probability of event occurrence, and the like) to the UE is higher (than a critical correlation), the message priority increases.
E. Consider changes in event information: After initial reception/processing of a received message including event/warning information, when there is no change in the event/warning information, the weight of the processing priority for the received message is reduced (while processing is performed periodically to remind about the warning), and when a change in the event/warning information is detected, the weight of the processing priority for the received message is increased.
F. Consider QoS management: The priority weight of messages (increase/decrease) based on an expected level at which the current reception UE is capable of satisfying the requirements/QoS of V2X application-related messages may be adjusted.
G. Consider geographical location: When there are UEs using V2X applications greater than or equal to a certain level in the geographical location of the reception UE, the priority weight of messages based on the V2X application increases, and the priority weight of messages based on V2X application used equal to or less than the certain level decreases.
H. Consider history information of reception UE: The priority weight for each message according to the characteristics of a user of the reception UE based on the past history information of the reception UE (movement path, movement speed, movement direction, and the like) may be adjusted (increased/decreased).
I. Consider inter-delay: As a processing time interval for the same type of messages received from a specific transmission UE is increased, the priority weight is increased.
J. Consider information of transmission UE: When different types of messages are transmitted from the same transmission UE or ITS-S, priority weight is increased for messages with high priority (or low priority value) applied in the transmitting stage, such as PPPP or QCI (to prevent and compensate for duplicate priority adjustments in the transmitting/receiving stage).
K. Consider subscription information: For V2X services subscribed/requested by the reception UE and messages for the V2X services, the priority weight is increased, and for messages for V2X services, the priority weight is decreased when a request to unsubscribe is made. Alternatively, the priority weight is applied to V2X services subscribed/requested by the reception UE and messages for the V2X services, and if a subscription is requested to be canceled, the priority weighting is not applied to messages for the V2X services.
L. Consider trust level of message: When a trust level of the received message is higher than a certain upper limit value (or a certain critical upper limit level) (when reaction of the reception UE due to the received message is required), the priority weight for the message is increased; when it is lower than a certain lower limit value (or a certain critical upper limit level) (when the reaction of the reception UE to the received message is not necessary or it is not a problem even if no reaction is made), the priority weight for the message is decreased.
4. Terminate message processing algorithm operation according to reception UE condition: When the processing volume level of the reception UE is x (0 to 100) % or more compared to the amount of messages received, the message processing algorithm operation is stopped.

Hereinafter, a method of determining a priority for each message based on a priority weight described above will be described in detail.

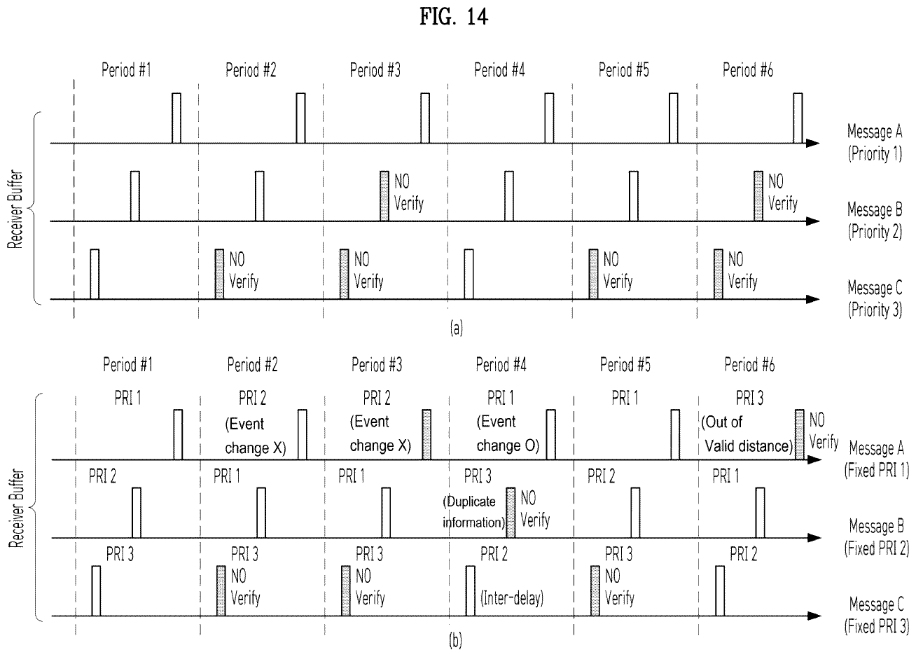

FIG. 14 is a diagram illustrating a method of determining a priority for each message type.

Referring to FIGS. 14(a) and (b), a reception UE may receive three messages with different fixed priorities and process the three messages based on the priorities. To facilitate a distinction between the three messages transmitted from different transmission UEs (or objects) in FIG. 14, each message is shown separately, but the three messages are stored in a buffer of one reception UE for each period. The reception UE may determine whether to proceed with additional subsequent processing procedures based on priorities of the messages after confirming (or completing decoding) only the basic information (basic status information, message type, and the like) included in the messages.

In detail, referring to FIG. 14(a), the reception UE may periodically receive a message A, a message B, and a message C. The reception UE may determine whether to perform subsequent processing on the message A, the message B, and the message C based on fixed priorities. For example, the reception UE may process and verify all three messages A with a priority 1 that are received periodically without filtering. The reception UE may process and verify two messages among three messages B with a priority 2, and filter one message. The reception UE may process and verify one message among three messages C with a priority 3 received periodically, and filter two messages.

Referring to FIG. 14(b), the reception UE may adjust/change/determine a priority weight for the received message based on an interaction between the transmission UE and the reception UE for each message reception period and the importance of information included in the received message, and may relatively adjust/change a processing priority (e.g., the fixed priority described based on FIG. 14(a)) of the received message for each period based on the priority weight (i.e., adaptive processing priority). For example, in cycle #1, when the messages A to C are first received, the reception UE may process/verify all the messages A to C without filtering. The message A received in cycle #2 may not have any change in event information compared to the message A received in cycle #1. In this case, the reception UE may lower the priority of the message A by applying a priority weight (or a reduction in the priority weight) that lowers the fixed processing priority of the message A to the fixed processing priority of the message A. Accordingly, in cycle #2, the priority for the message A may be relatively lower than the priority for the message B. As a result, the messages A and B with the priorities 1 and 2 may be processed/verified subsequently, but the message C may be filtered.

In cycle #3, the event information of the message A may not change continuously. In this case, the reception UE may lower the processing priority of the message A (than the processing priority of the message A in cycle #2) by applying a priority weight (or a reduction in the priority weight) that lowers the fixed processing priority of the message A to the fixed processing priority of the message A. Accordingly, the message A may be filtered in cycle #3. In cycle #4, there may be a change in the event information contained in message A, and there may be no change in the event information contained in the message B. In this case, the priority weight for the message A may be applied to increase the priority of the message A, and the priority weight (or reduction of the priority weight) that lowers the fixed processing priority for the message B may be applied to the fixed processing priority for the message B to lower the priority of the message B. In cycle #4, the message C may have its priority weight increased/applied when a message processing time interval exceeds a certain time (or exceeds a certain threshold time). In this case, the message processing priority levels may increase in the order of messages A, C, and B, and the reception UE may perform subsequent processing on the messages A and C and filter the message B.

Cycle #5 may not have any situation/condition to change/adjust/apply priority weights for the messages A, B and C. In this case, the reception UE may determine/readjust the processing priorities of messages in the order of the messages A, B, and C by applying the fixed priority weights (or default priority weights) described based on FIG. 14(a). In cycle #6, a predetermined valid distance may be exceeded based on the information contained in the message A. In this case, the reception UE may lower the processing priority for the message A by reducing the priority weight for the message A. In this case, the message A may be filtered. In cycle #6, the messages B and C may be reprioritized to be relatively higher in priority than the message A.

As such, the message processing priority may be dynamically adjusted/changed by comprehensively considering information on the transmission/reception UE, surrounding traffic, environmental information, and the like from a fixed default priority weight. When the reception UE is overloaded with processing messages, the same amount of messages are filtered in the cases of FIGS. 14(a) and 14(b), but the reception UE may obtain/process necessary information more efficiently in the case of FIG. 14(b) than in the case of FIG. 14(a).

For convenience of explanation, an example is given of a situation in which three different messages are received, however, in more congested situations, a greater number and type of messages may be received and processed in the manner described above. A level of applied priority weights may be flexibly adjusted depending on the status of the transmission/reception UE and traffic conditions. By considering the UE status, message information, surrounding traffic, and road environment through the proposed method described above, messages with high current priority may be appropriately adjusted and processed, thereby managing the QoS of V2X services and improving the overall V2X service quality. The proposed method may be utilized regardless of the type of reception UE (vehicle, VRU, RSU, server, and the like), the casting method of the received message (Unicast, Broadcast, Groupcast), and the communication method (Short range communication (V2V, V21), Long range communication (V2N)).

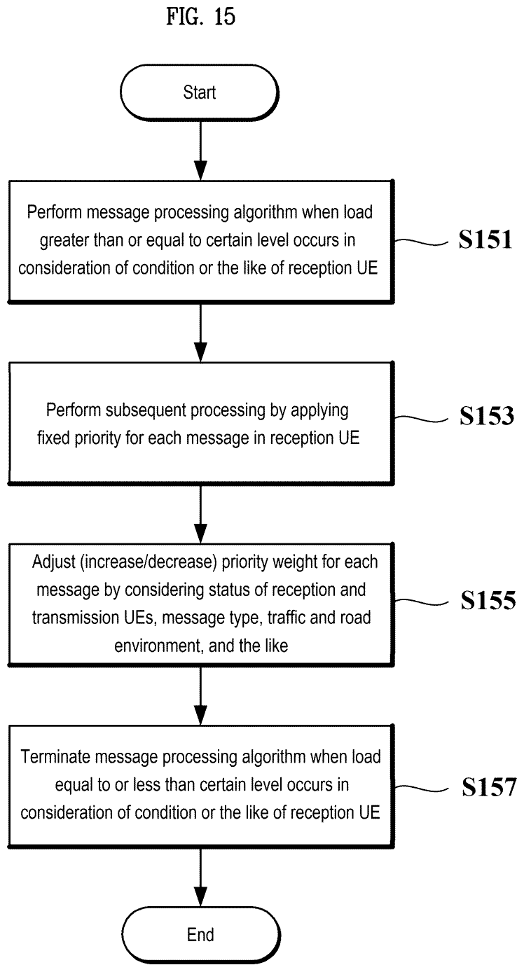

FIG. 15 is a flowchart illustrating a method of applying a priority weight to a default priority per message.

Referring to FIG. 15, when a load greater than or equal to a certain level occurs (e.g., when a processing volume level of a reception UE is x (0 to 100) % or less compared to a message reception volume of the reception UE) based on the message processing capability of the reception UE, the reception UE may perform a processing operation on the received messages based on a message processing algorithm (S151).

Then, the reception UE may perform subsequent processing order and/or message filtering operation of the received messages by applying a fixed default processing priority for each message/message type (S153). Then, the reception UE may adjust (increase/decrease) the priority weight to be applied to determining the processing priority for each message/message type by considering the status of the reception UE and the transmission UE, the message type, the surrounding environment (traffic conditions, road environment, and the like) (S155). Then, when a load equal to or less than a certain level occurs (e.g., when a processing volume level of a reception UE is x (0 to 100) % or more compared to a message reception volume of the reception UE) based on the message processing capability of the reception UE, the reception UE may terminate a processing operation on the received messages based on a message processing algorithm (S157).

When the at least one message described above is a message related to a SoftV2X service, a network or server providing the SoftV2X service may receive at least one message related to V2X from at least one transmission UE, such as the reception UE described above. In this case, the network or server may perform the operation described above related to a processing priority for the received message of the reception UE. That is, the reception UE described above may be replaced by a network/server, and operations related to the processing priority described above may be applied.

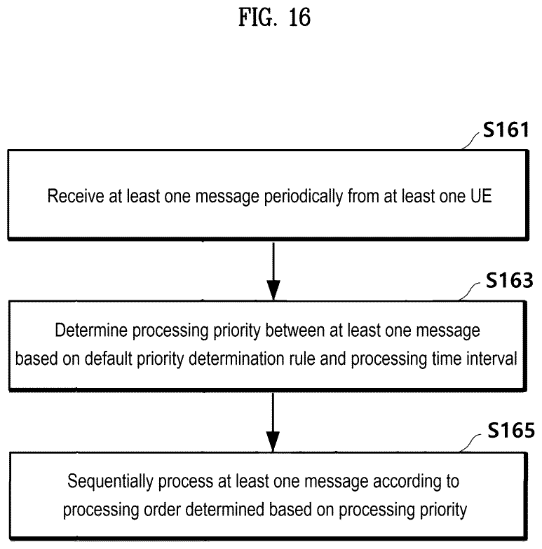

FIG. 16 is a diagram for explaining a method of determining a processing priority of received messages by a UE.

Referring to FIG. 16, the UE may periodically receive at least one message from at least one UE (S161). For example, the UE may periodically receive a plurality of messages, such as recognition messages, warning messages, and sensing messages, transmitted by each of the surrounding UEs. The UE may periodically receive at least one message from at least one UE, as illustrated in FIGS. 11 and 14. The UE may perform processing on at least one message when at least one message of the at least one UE initially received. Then, the UE may determine whether to determine the processing order for at least one message received periodically based on its processing capability, and the like. The UE may determine the processing priority for each message/UE as described below when it is necessary to determine the processing order.

The UE may determine a processing priority among at least one message received from the at least one UE (S163). In detail, the UE may determine the processing priority among the at least one message based on a default priority determination rule, but may determine or adjust the processing priority by further considering a processing time interval between messages for the same UE. Here, as described above, the default priority determination rule may include at least one of a priority determination rule based on a time stored in a buffer of a UE, a priority determination rule based on a distance between the at least one UE and the UE, a priority determination rule based on mobility information (movement direction, movement speed) of the at least one UE, and a priority determination rule based on a driving environment (existence of a boundary obstacle with a lane in a different direction, number of lanes on a road, and the like). The default priority determination rule may be a rule to be applied to determining the processing priority between messages of the same type, and may not be applied to determining the processing priority between messages of different types.

The processing time interval of messages may be a time interval from a time of reception of the last message for which subsequent processing is performed (or a time of performing subsequent processing) to a time of reception of the currently received message in relation to messages received periodically as described in FIGS. 11 to 15 for the same UE. For example, if the UE periodically receives the first message from the first UE, the processing time interval of the messages may be a time interval from the time of reception of the most recent message of the first UE that has completed subsequent processing to the time of reception of the message of the first UE that requires subsequent processing.

In detail, the UE may determine whether to additionally consider/apply a priority weight (or a first weight) to a processing priority according to a default priority determination rule based on whether the processing time interval of messages for the same UE is greater than or equal to a threshold time. When the processing time interval for a first UE among the at least one UE is greater than or equal to a threshold time, the UE may determine a processing priority for the message of the first UE by applying the priority weight to the processing priority for the message of the first UE in determining the processing priority according to the default priority determination rule. In this case, the processing priority for the first UE to which the priority weight is applied may be higher than the processing priority determined only by the default priority determination rule. Alternatively, the UE may apply the priority weight to a specific value for the first UE considered in the default priority determination rule, and then determine the processing priority based on the specific value to which the priority weight is applied. In contrast, when the processing time interval for the first UE among the at least one UE is less than the threshold time, the UE may determine the priority for the message of the first UE by considering only the default priority determination rule.

Alternatively, the UE may determine/set a first weight, which is the priority weight, based on the size of the processing time interval. For example, the UE may increase the first weight depending on an extent to which the processing time interval is longer than the threshold time. Alternatively, the UE may determine the first weight based on the message processing capability of the UE and mobility information included in the message of the first UE. For example, when the first UE moves in a direction in which a distance between the first UE and the UE increases, the UE may determine/set a value smaller than the default weight as the first weight. The UE may determine/set the first weight as described in FIGS. 11 to 15. Alternatively, the UE may determine/set a specific threshold time based on the message type of the first UE and the mobility information of the first UE included in the message of the UE. Detailed application examples are as described with reference to FIGS. 11 to 15.

When at least one message received from at least one UE is of a different message type, the reception UE may determine a processing priority between messages of different types by applying a second weight to the default priority for each type of message. That is, the default priority determination rule may be applied to determine a processing priority between messages of the same type as described above (see FIGS. 11 and 12), and a separate default priority for each message type may be applied to determine the processing priority between messages of different types. In detail, the processing priority between messages of different types may be determined by applying a second weight determined based on at least one of the status of the reception UE, event information of the message, priority related to transmission of the message, the processing time interval, and the reliability level of the message to the priority determined based on the default priority for each message type (see FIGS. 13 to 15).

Then, the UE may sequentially process at least one message received periodically according to a processing order determined based on the determined/set processing priority (S165). Here, the processing of the message may be an operation of verifying the certificate of the message that is completely decoded as described above, processing encrypted data, and verifying the validity of the data. One or more of the at least one message may be filtered/discarded according to the determined processing order. For example, when processing at least one message sequentially according to the determined processing order, the UE may discard (i.e., filter out some messages) one or more messages that are not processed and stored in the buffer until a preset discard time has elapsed among the at least one message. A processing time interval increases in the case of a discarded message, and thus the UE may additionally apply a first weight to the message of the transmission UE when receiving a message from the same transmission UE that transmitted the discarded message. In this case, the processing priority for the message of the transmission UE is set higher than before, and thus the possibility of the message of the transmission UE being additionally discarded at the UE may be reduced.

When a server or network providing a V2N service or the SoftV2X service described above receives at least one message as described above, the server or network may also determine a processing priority for at least one received message based on a default priority determination rule and a processing time interval of messages for the same UE in the same manner as the message receiving operation of the UE described above, and may sequentially process at least one message. That is, the method of receiving at least one message described above may naturally be applied to the receiving operation of messages received from UEs of the server or network.

As such, the proposed disclosure may significantly reduce a rate of information loss caused by repeated processing omission of some messages due to existing processing priority determination conditions/filtering conditions for received messages. Alternatively, the proposed disclosure may prevent repeated processing omissions of messages received from a specific UE for a predetermined period of time or longer by adjusting priorities based on a processing time interval of received messages, thereby minimizing the occurrence of risk situations due to unexpected path changes/mobility changes for the specific UE. Alternatively, the proposed disclosure may significantly improve the reliability and quality of V2X service provision by dynamically adjusting the processing priority, threshold related to the processing priority, and priority weight for the received message by additionally considering the relationship between the reception UE and the transmission UE, the surrounding environment, mobility information of the transmission UE, and the like.

Communication System Example to which the Present Disclosure is Applied

Although not limited thereto, various descriptions, functions, procedures, proposals, methods, and/or operational flow charts of the present disclosure disclosed in this document may be applied to various fields requiring wireless communication/connection (5G) between devices.

Hereinafter, it will be illustrated in more detail with reference to the drawings. In the following drawings/description, the same reference numerals may exemplify the same or corresponding hardware blocks, software blocks, or functional blocks, unless otherwise indicated.

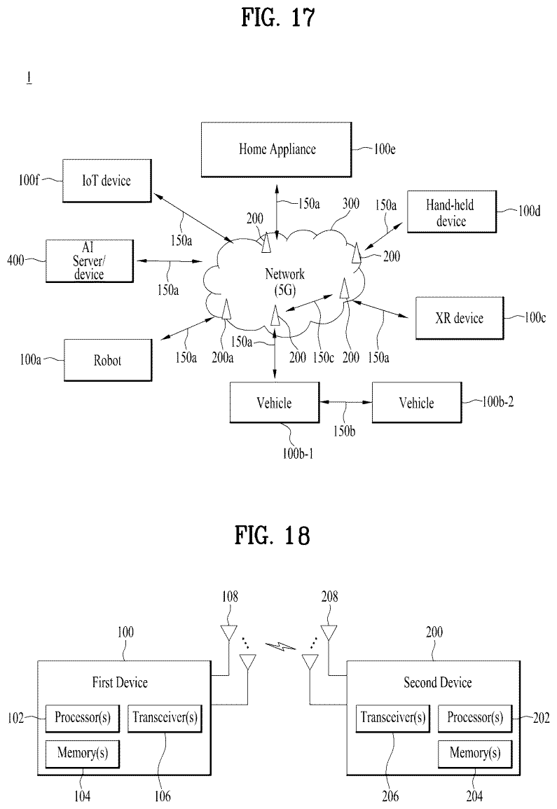

FIG. 17 illustrates a communication system applied to the present disclosure.

Referring to FIG. 17, a communication system 1 applied to the present disclosure includes wireless devices, Base Stations (BSs), and a network. Herein, the wireless devices represent devices performing communication using Radio Access Technology (RAT) (e.g., 5G New RAT (NR)) or Long-Term Evolution (LTE)) and may be referred to as communication/radio/5G devices. The wireless devices may include, without being limited to, a robot 100a, vehicles 100b-1 and 100b-2, an extended Reality (XR) device 100c, a hand-held device 100d, a home appliance 100e, an Internet of Things (IoT) device 100f, and an Artificial Intelligence (AI) device/server 400. For example, the vehicles may include a vehicle having a wireless communication function, an autonomous driving vehicle, and a vehicle capable of performing communication between vehicles. Herein, the vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device 200a may operate as a BS/network node with respect to other wireless devices.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g. Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b, or 150c may be established between the wireless devices 100a to 100f/BS 200, or BS 200/BS 200. Herein, the wireless communication/connections may be established through various RATs (e.g., 5G NR) such as uplink/downlink communication 150a, sidelink communication 150b (or, D2D communication), or inter BS communication (e.g. relay, Integrated Access Backhaul (IAB)). The wireless devices and the BSs/the wireless devices may transmit/receive radio signals to/from each other through the wireless communication/connections 150a and 150b. For example, the wireless communication/connections 150a and 150b may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present disclosure.

Examples of Wireless Devices to which the Present Disclosure is Applied

FIG. 18 illustrates a wireless device applicable to the present disclosure.

Referring to FIG. 18, a first wireless device 100 and a second wireless device 200 may transmit radio signals through a variety of RATs (e.g., LTE and NR). Herein, {the first wireless device 100 and the second wireless device 200} may correspond to {the wireless device 100x and the BS 200} and/or {the wireless device 100x and the wireless device 100x} of FIG. 17.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operational flowcharts disclosed in this document. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver 106 and then store information acquired by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, proposals, methods, and/or operational flowcharts disclosed in this document. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with Radio Frequency (RF) unit(s). In the present disclosure, the wireless device may represent a communication modem/circuit/chip.

The first wireless device or UE 100 may include the processor 102 and the memory 104 connected to the transceiver 106. The memory 104 may include at least one program for performing operations related to the embodiments described in FIGS. 11 to 16.

The processor 102 may control the transceiver 106 to periodically receive at least one message from at least one UE, and to process the at least one message according to a message processing order determined based on a processing priority, and in this case, the processing priority may be determined based on a default priority determination rule and a processing time interval of messages for the same UE.

Alternatively, a processing device may be configured to control a UE including the processor 102 and the memory 104. The processing device may include at least one processor and at least one memory connected to the at least one processor and storing instructions, and in this case, the instructions may, based on execution by the at least one processor, cause the UE to periodically receive at least one message from at least one UE, and process the at least one message according to a message processing order determined based on a processing priority. Here, the processing priority may be determined based on a default priority determination rule and a processing time interval of messages for the same UE.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operational flowcharts disclosed in this document. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information acquired by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, proposals, methods, and/or operational flowcharts disclosed in this document. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present disclosure, the wireless device may represent a communication modem/circuit/chip.

In detail, the second wireless device or network/server 200 may include the processor 202 and the memory 204 connected to the transceiver 206. The memory 204 may include at least one program for performing operations related to the embodiments described in FIGS. 11 to 16.

The processor 202 may control the transceiver 206 to periodically receive at least one message from at least one UE, and to process the at least one message according to a message processing order determined based on a processing priority, and in this case, the processing priority may be determined based on a default priority determination rule and a processing time interval of messages for the same UE.

Alternatively, a processing device may be configured to control the network/server 200 including the processor 202 and the memory 204. The processing device may include at least one processor and at least one memory connected to the at least one processor and storing instructions, and in this case, the instructions may, based on execution by the at least one processor, cause the network to periodically receive at least one message from at least one UE, and process the at least one message according to a message processing order determined based on a processing priority. Here, the processing priority may be determined based on a default priority determination rule and a processing time interval of messages for the same UE.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as PHY, MAC, RLC, PDCP, RRC, and SDAP). The one or more processors 102 and 202 may generate one or more Protocol Data Units (PDUs) and/or one or more Service Data Unit (SDUs) according to the descriptions, functions, procedures, proposals, methods, and/or operational flowcharts disclosed in this document. The one or more processors 102 and 202 may generate messages, control information, data, or information according to the descriptions, functions, procedures, proposals, methods, and/or operational flowcharts disclosed in this document. The one or more processors 102 and 202 may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operational flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors 102 and 202 or stored in the one or more memories 104 and 204 so as to be driven by the one or more processors 102 and 202. The descriptions, functions, procedures, proposals, methods, and/or operational flowcharts disclosed in this document may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by Read-Only Memories (ROMs), Random Access Memories (RAMs), Electrically Erasable Programmable Read-Only Memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of this document, to one or more other devices. The one or more transceivers 106 and 206 may receive user data, control information, and/or radio signals/channels, mentioned in the descriptions, functions, procedures, proposals, methods, and/or operational flowcharts disclosed in this document, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices. The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, proposals, methods, and/or operational flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

Examples of Wireless Devices to which the Present Disclosure is Applied

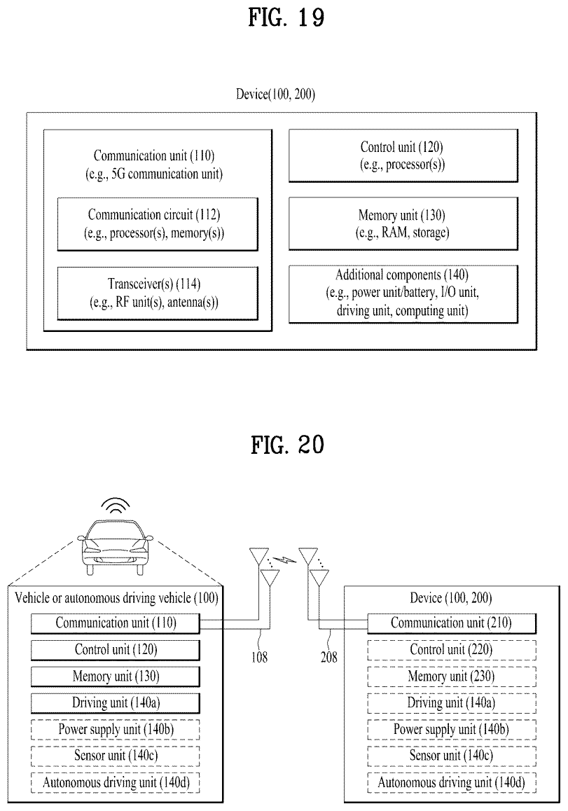

FIG. 19 illustrates another example of a wireless device applied to the present disclosure. The wireless device may be implemented in various forms according to a use-case/service (refer to FIG. 17)

Referring to FIG. 19, wireless devices 100 and 200 may correspond to the wireless devices 100 and 200 of FIG. 18 and may be configured by various elements, components, units/portions, and/or modules. For example, each of the wireless devices 100 and 200 may include a communication unit 110, a control unit 120, a memory unit 130, and additional components 140. The communication unit may include a communication circuit 112 and transceiver(s) 114. For example, the communication circuit 112 may include the one or more processors 102 and 202 and/or the one or more memories 104 and 204 of FIG. 18. For example, the transceiver(s) 114 may include the one or more transceivers 106 and 206 and/or the one or more antennas 108 and 208 of FIG. 18. The control unit 120 is electrically connected to the communication unit 110, the memory 130, and the additional components 140 and controls overall operation of the wireless devices. For example, the control unit 120 may control an electric/mechanical operation the of wireless device based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of wireless devices. For example, the additional components 140 may include at least one of a power unit/battery, input/output (I/O) unit, a driving unit, and a computing unit. The wireless device may be implemented in the form of, without being limited to, the robot (100a of FIG. 17), the vehicles (100b-1 and 100b-2 of FIG. 17), the XR device (100c of FIG. 17), the hand-held device (100d of FIG. 17), the home appliance (100e of FIG. 17), the IoT device (100f of FIG. 17), a digital broadcast terminal, a hologram device, a public safety device, an MTC device, a medicine device, a fintech device (or a finance device), a security device, a climate/environment device, the AI server/device (400 of FIG. 17), the BSs (200 of FIG. 17), a network node, etc. The wireless device may be used in a mobile or fixed place according to a use-example/service.

In FIG. 19, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor, an Electronic Control Unit (ECU), a graphical processing unit, and a memory control processor. As another example, the memory 130 may be configured by a Random Access Memory (RAM), a Dynamic RAM (DRAM), a Read Only Memory (ROM)), a flash memory, a volatile memory, a non-volatile memory, and/or a combination thereof.

Examples of Vehicles or Autonomous Vehicles to which the Present Disclosure is Applied

FIG. 20 illustrates a vehicle or an autonomous driving vehicle applied to the present disclosure. The vehicle or autonomous driving vehicle may be implemented by a mobile robot, a car, a train, a manned/unmanned Aerial Vehicle (AV), a ship, etc.

Referring to FIG. 20, a vehicle or autonomous driving vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as a part of the communication unit 110. The blocks 110/130/140a to 140d correspond to the blocks 110/130/140 of FIG. 17, respectively.

The communication unit 110 may transmit and receive signals (e.g., data and control signals) to and from external devices such as other vehicles, BSs (e.g., gNBs and road side units), and servers. The control unit 120 may perform various operations by controlling elements of the vehicle or the autonomous driving vehicle 100. The control unit 120 may include an Electronic Control Unit (ECU). Also, the driving unit 140a may cause the vehicle or the autonomous driving vehicle 100 to drive on a road. The driving unit 140a may include an engine, a motor, a powertrain, a wheel, a brake, a steering device, etc. The power supply unit 140b may supply power to the vehicle or the autonomous driving vehicle 100 and include a wired/wireless charging circuit, a battery, etc. The sensor unit 140c may acquire a vehicle state, ambient environment information, user information, etc. The sensor unit 140c may include an Inertial Measurement Unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, etc. The autonomous driving unit 140d may implement technology for maintaining a lane on which a vehicle is driving, technology for automatically adjusting speed, such as adaptive cruise control, technology for autonomously driving along a determined path, technology for driving by automatically setting a path if a destination is set, and the like.

For example, the communication unit 110 may receive map data, traffic information data, etc. from an external server. The autonomous driving unit 140d may generate an autonomous driving path and a driving plan from the acquired data. The control unit 120 may control the driving unit 140a such that the vehicle or the autonomous driving vehicle 100 may move along the autonomous driving path according to the driving plan (e.g., speed/direction control). In the middle of autonomous driving, the communication unit 110 may aperiodically/periodically acquire recent traffic information data from the external server and acquire surrounding traffic information data from neighboring vehicles. In the middle of autonomous driving, the sensor unit 140c may obtain a vehicle state and/or surrounding environment information. The autonomous driving unit 140d may update the autonomous driving path and the driving plan based on the newly acquired data/information. The communication unit 110 may transfer information about a vehicle position, the autonomous driving path, and/or the driving plan to the external server. The external server may predict traffic information data using AI technology, etc., based on the information collected from vehicles or autonomous driving vehicles and provide the predicted traffic information data to the vehicles or the autonomous driving vehicles.

Here, wireless communication technologies implemented in the wireless devices (XXX, YYY) of the present specification may include LTE, NR, and 6G, as well as Narrowband Internet of Things for low power communication. At this time, for example, the NB-IoT technology may be an example of a Low Power Wide Area Network (LPWAN) technology, and may be implemented in standards such as LTE Cat NB1 and/or LTE Cat NB2, and is not limited to the above-described names. Additionally or alternatively, the wireless communication technology implemented in the wireless devices (XXX, YYY) of the present specification may perform communication based on LTE-M technology. In this case, as an example, the LTE-M technology may be an example of LPWAN technology, and may be referred to by various names such as eMTC (enhanced machine type communication). For example, LTE-M technology may be implemented in at least one of a variety of standards, such as 1) LTE CAT 0, 2) LTE Cat M1, 3) LTE Cat M2, 4) LTE non-BL (non-Bandwidth Limited), 5) LTE-MTC, 6) LTE Machine Type Communication, and/or 7) LTE M, and is not limited to the above-described names. Additionally or alternatively, the wireless communication technology implemented in the wireless devices (XXX, YYY) of the present specification is at least one of ZigBee, Bluetooth, and Low Power Wide Area Network (LPWAN) considering low power communication, and is not limited to the above-described names. As an example, ZigBee technology can generate personal area networks (PANs) related to small/low-power digital communication based on various standards such as IEEE 802.15.4, and may be called various names.

The embodiments described above are those in which components and features of the present disclosure are combined in a predetermined form. Each component or feature should be considered optional unless explicitly stated otherwise. Each component or feature may be implemented in a form that is not combined with other components or features. In addition, it is also possible to constitute an embodiment of the present disclosure by combining some components and/or features. The order of operations described in the embodiments of the present disclosure may be changed. Some configurations or features of one embodiment may be included in other embodiments, or may be replaced with corresponding configurations or features of other embodiments. It is obvious that the embodiments may be configured by combining claims that do not have an explicit citation relationship in the claims or may be included as new claims by amendment after filing.

In this document, embodiments of the present disclosure have been mainly described based on a signal transmission/reception relationship between a terminal and a base station. Such a transmission/reception relationship is extended in the same/similar manner to signal transmission/reception between a terminal and a relay or a base station and a relay. A specific operation described as being performed by a base station in this document may be performed by its upper node in some cases. That is, it is obvious that various operations performed for communication with a terminal in a network comprising a plurality of network nodes including a base station may be performed by the base station or network nodes other than the base station. The base station may be replaced by terms such as a fixed station, a Node B, an eNode B (eNB), an access point, and the like. In addition, the terminal may be replaced with terms such as User Equipment (UE), Mobile Station (MS), Mobile Subscriber Station (MSS).

In a hardware configuration, the embodiments of the present disclosure may be achieved by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, etc.

In a firmware or software configuration, a method according to embodiments of the present disclosure may be implemented in the form of a module, a procedure, a function, etc. Software code may be stored in a memory unit and executed by a processor. The memory unit is located at the interior or exterior of the processor and may transmit and receive data to and from the processor via various known means

As described before, a detailed description has been given of preferred embodiments of the present disclosure so that those skilled in the art may implement and perform the present disclosure. While reference has been made above to the preferred embodiments of the present disclosure, those skilled in the art will understand that various modifications and alterations may be made to the present disclosure within the scope of the present disclosure. For example, those skilled in the art may use the components described in the foregoing embodiments in combination. The above embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

### INDUSTRIAL APPLICABILITY

The embodiments of the present disclosure described above are applicable to various mobile communication systems.

1. A method by a user equipment (UE) comprising:
periodically receiving at least one message from at least one UE; and
processing the at least one message based on a message processing order,
wherein the message processing order is determined based on a processing priority,
wherein the processing priority is determined based on a default priority determination rule and a message processing time interval for each of the at least one UE.

2. The method of claim 1, wherein, based on the message processing time interval for a first UE among the at least one UE being greater than or equal to a specific threshold time, a processing priority for a message of the first UE is determined by applying a first weight to a priority determined based on the default priority determination rule.

3. The method of claim 2, wherein, based on the message processing time interval for the first UE being less than a specific threshold time, the processing priority for the message of the first UE is determined based only on the default priority determination rule without applying the first weight.

4. The method of claim 2, wherein the first weight is determined based on a size of the message processing time interval.

5. The method of claim 2, wherein the first weight is determined based on a message processing capability of the UE and mobility information included in a message of the first UE, and
the specific threshold time is changed based on a type of the message of the first UE and the mobility information of the first UE included in the message of the first UE.

6. The method of claim 1, wherein the default priority determination rule is a rule for determining a priority between messages of the same message type received periodically based on at least one of a time stored in a buffer of the UE, a distance between the at least one UE and the UE, mobility information of the at least one UE, or a driving environment.

7. The method of claim 1, wherein, when at least one message received from the at least one UE is of a different message type, the reception UE determines a processing priority between messages of different types by applying a second weight to the default priority for each type of the message.

8. The method of claim 7, wherein the second weight is determined based on at least one of a status of the reception UE, event information of a message, a priority related to transmission of the message, the message processing time interval, or a reliability level of the message.

9. The method of claim 1, wherein processing of the message includes operations of verifying a certificate for the received message, processing encrypted data, and verifying validity of data.

10. (canceled)

11. A user equipment (UE) comprising:
a radio frequency (RF) transceiver;
an acoustic sensor; and
a processor connected to the RF transceiver,
wherein the processor controls the RF transceiver to periodically receive at least one message from at least one UE and process the at least one message based on a message processing order,
wherein the message processing order is determined based on a processing priority, and the processing priority is determined based on a default priority determination rule and a message processing time interval for each of the at least one UE.

12. The UE of claim 11, wherein, based on the message processing time interval for a first UE among the at least one UE being greater than or equal to a specific threshold time, a processing priority for a message of the first UE is determined by applying a first weight to a priority for the first UE based on the default priority determination rule.

13. (canceled)

14. A method by a network comprising:
periodically receiving at least one message from at least one user equipment (UE); and
processing the at least one message based on a message processing order,
wherein the message processing order is determined based on a processing priority,
wherein the processing priority is determined based on a default priority determination rule and a message processing time interval for each of the at least one UE.

15. (canceled)
